(19) United States
(12) Patent Application Publication
(10) Pub. No.: US 2018/0095374 A1
(43) Pub. Date: Apr. 5, 2018

(54) MIXTURE, TONER, AND DISPERSION

(71) Applicant: CANON KABUSHIKI KAISHA, Tokyo (JP)

(72) Inventor: Takeshi Sekiguchi, Kawasaki-shi (JP)

(21) Appl. No.: 15/717,563

(22) Filed: Sep. 27, 2017

(30) Foreign Application Priority Data
Sep. 30, 2016 (JP) 2016-192724

(51) Int. Cl. G03G 9/09; C09B 23/01; C09B 29/036; C09B 67/22; C09B 67/46

(52) U.S. Cl. CPC G03G 9/0916; G03G 9/091; C09B 67/0084; C09B 29/0048; C09B 67/004; C09B 23/0075

(57) ABSTRACT

A mixture contains a compound having a specific structure and acting as a dye and a compound having a specific structure and acting as an ultraviolet light absorbent.

### BACKGROUND OF THE INVENTION

### Field of the Invention

The present disclosure relates to a thiazolemethinepyridone dye mixture suitable as a colorant used in recording methods such as an electrophotographic method, an electrostatic recording method, a magnetic recording method, and a toner jet method. The present disclosure also relates to a pyridone azo dye mixture suitable as a colorant of a yellow toner. Furthermore, the disclosure relates to a toner and a dispersion, each containing such a dye mixture.

### Description of the Related Art

A demand for higher-quality color images is increasing, and it is desirable that the performance, in terms of color developability and fastness to light, of the colorants in the toners be improved. Accordingly, it has been studied to use a dye as a colorant in toners for each color.

WO95/17470 discloses various thiazolemethinepyridone dyes. WO2014/034095 and WO2014/034096 disclose toners containing a thiazolemethinepyridone dye having specific substituents at specific positions. Japanese Patent Laid-Open No. 2011-257706 discloses a toner containing a pyridone azo dye. Japanese Patent Laid-Open No. 2013-209638 discloses a composition containing a pigment and a pyridone azo dye having specific substituents at specific positions.

However, color fading is an issue of dyes. According to Osaka Kyoiku University Kenkyu-kiyo (Bulletin of Osaka Kyoiku University) III, Vol. 62, No. 2, pp. 13-22 (February 2014), color fading in dyes can be suppressed by using an ultraviolet light absorbent. However, some combinations of a dye and an ultraviolet light absorbent have degraded light fastness or have not sufficiently improved light fastness.

There is room for improvement in light fastness of the dyes and toners disclosed in the above-cited documents.

### SUMMARY OF THE INVENTION

The present disclosure provides a mixture, a toner, and a dispersant that are superior in fastness to light.

According to an aspect of the present disclosure, there is provided a mixture containing a compound (dye) represented by one of the following general formulas (1) and (6), and at least one compound (ultraviolet light absorbent) selected from the compounds represented by the following general formulas (2) to (5).

The present disclosure is also directed to a toner and a dispersion, each containing a compound (dye) represented by one of the following general formulas (1) and (6), and at least one compound (ultraviolet light absorbent) selected from the compounds represented by the following general formulas (2) to (5).

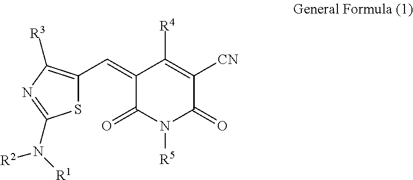

In general formula (1), R¹ and R² each represents an alkyl group. R³ represents a chemical species selected from the group consisting of a hydrogen atom, alkyl groups, unsubstituted aryl groups, and substituted aryl groups. R⁴ represents a chemical species selected from the group consisting of alkyl groups, unsubstituted aryl groups, and substituted aryl groups. R⁵ represents a chemical species selected from the group consisting of a hydrogen atom, alkyl groups, unsubstituted aryl groups, substituted aryl groups, and —N(—R⁶)R⁷, wherein R⁶ and R⁷ each independently represent a chemical species selected from the group consisting of a hydrogen atom, alkyl groups, and acyl groups, or represent atomic groups capable of binding with each other to form a ring structure.

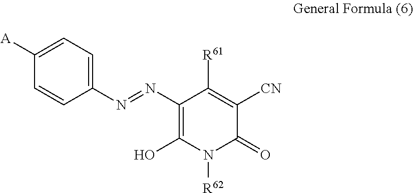

In general formula (6), R⁶¹ and R⁶² each represents an alkyl group, and A represents a group selected from the group consisting of —SO₂N(R⁶³)R⁶⁴, —CON(R⁶³)R⁶⁴, and —COOR⁶³, wherein R⁶³ and R⁶⁴ each independently represent a chemical species selected from the group consisting of a hydrogen atom and alkyl groups.

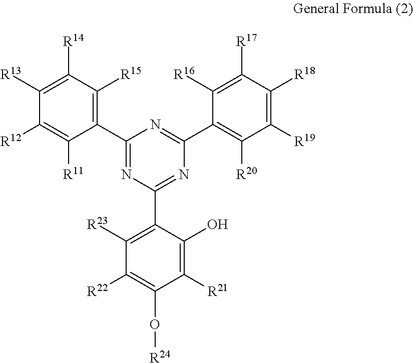

In general formula (2), R¹¹ and R¹⁶ each independently represent a chemical species selected from the group consisting of a hydrogen atom, alkyl groups, alkoxy groups, and a hydroxy group. R¹², R¹⁴, R¹⁵, R¹⁷, R¹⁹, R²⁰, R²¹, R²², and R²³ each independently represent a chemical species selected from the group consisting of a hydrogen atom and alkyl groups. R¹³ and R¹⁸ each independently represent a chemical species selected from the group consisting of a hydrogen atom, alkyl groups, and alkoxy groups. represents a chemical species selected from the group consisting of a hydrogen atom, alkyl groups, and alkyl groups having a hydroxy group.

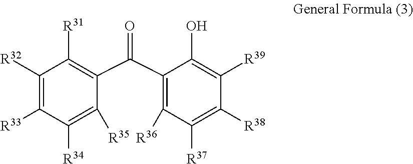

In general formula (3), R³¹ represents a chemical species selected from the group consisting of a hydrogen atom, alkyl groups, and a hydroxy group. R³², R³⁴, R³⁵, R³⁶, R³⁷, and R³⁹ each independently represent a chemical species selected from the group consisting of a hydrogen atom and alkyl groups, and R³³ and R³⁸ each independently represent a chemical species selected from the group consisting of a hydrogen atom, a hydroxy group, and alkoxy groups.

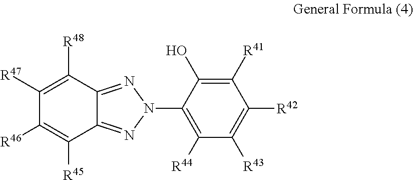

In general formula (4), R⁴¹ and R⁴³ each independently represent a chemical species selected from the group consisting of a hydrogen atom, alkyl groups, unsubstituted aryl groups, and substituted aryl groups, and R⁴² and R⁴⁴ to R⁴⁸ each independently represent a chemical species selected from the group consisting of a hydrogen atom and alkyl groups.

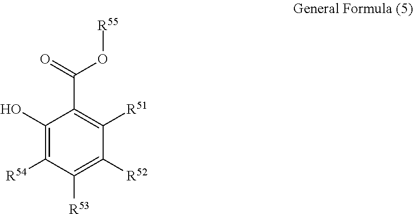

In general formula (5), R⁵¹ to R⁵⁴ each independently represent a chemical species selected from the group consisting of a hydrogen atom and alkyl groups, and R⁵⁵ represents a chemical species selected from the group consisting of alkyl groups, alkyl groups having an aryl group as a substituent, unsubstituted aryl groups, and substituted aryl groups.

Further features of the present disclosure will become apparent from the following description of exemplary embodiments.

### DESCRIPTION OF THE EMBODIMENTS

The subject matter of the present disclosure will be further described in detail using exemplary embodiments.

The mixture according to an embodiment of the present disclosure contains a compound (dye) represented by one of the following general formulas (1) and (6), and at least one compound (ultraviolet light absorbent) selected from the compounds represented by the following general formulas (2) to (5). In the mixture, the color of the dye does not fade much and can be kept clear for a long time.

A toner or a dispersion (ink) containing the mixture can form images having a color that can be kept clear for a long time.

### Magenta Dye

A Magenta dye (thiazolemethinepyridone dye) represented by general formula (1) will now be described.

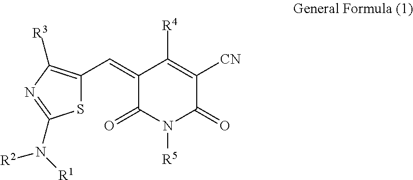

In general formula (1), R¹ and R² each represents an alkyl group, and R³ represents a chemical species selected from the group consisting of a hydrogen atom, alkyl groups, unsubstituted aryl groups, and substituted aryl groups. R⁴ represents a chemical species selected from the group consisting of alkyl groups, unsubstituted aryl groups, and substituted aryl groups. R⁵ represents a chemical species selected from the group consisting of a hydrogen atom, alkyl groups, unsubstituted aryl groups, substituted aryl groups, and —N(—R⁶)R⁷, wherein R⁶ and R⁷ each independently represent a chemical species selected from the group consisting of a hydrogen atom, alkyl groups, and acyl groups, or represent atomic groups capable of binding with each other to form a ring structure.

The compound represented by general formula (1) may be a compound in which R¹ and R² are each an alkyl group; R³ is a chemical species selected from the group consisting of alkyl groups, unsubstituted aryl groups, and substituted aryl groups; R⁴ is an alkyl group; and R⁵ is a group selected from the group consisting of alkyl groups and —N(—R⁶)R⁷, wherein R⁶ and R⁷ are each independently a chemical species selected from the group consisting of a hydrogen atom, alkyl groups, and acyl groups.

The alkyl groups represented by R¹ and R² in general formula (1) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl. Branched alkyl groups are more beneficial in terms of high chroma and wide-range color reproduction and for increasing fastness to light. In particular, the 2-ethylhexyl group is beneficial.

The alkyl group represented by R³ in general formula (1) may be, but is not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl. The tert-butyl group is more beneficial in terms of high chroma and wide-range color reproduction and for increasing fastness to light.

The aryl group represented by R³ in general formula (1) may be, but is not limited to, phenyl. If the aryl group has a substituent, the substituent may be methyl, ethyl, or methoxy. Examples of the substituted aryl group include 2-methylphenyl, 3-methyphenyl, 4-methylphenyl, 2,6-dimethylphenyl, 2,6-diethylphenyl, 2,4,6-trimethylphenyl, 2,4,6-triethylphenyl, 3-methoxyphenyl, and 2,6-dimethoxyphenyl.

The alkyl group represented by R⁴ in general formula (1) may be, but is not limited to, an alkyl group having a carbon number of 1 to 4. More specifically, examples thereof include methyl, ethyl, n-propyl, isopropyl, n-butyl, isobutyl, 2-methylbutyl, and 2,3,3-trimethylbutyl. The methyl group is more beneficial in terms of high chroma and wide-range color reproduction and for increasing fastness to light.

The aryl group represented by R⁴ in general formula (1) may be, but is not limited to, phenyl. If the aryl group has a substituent, the substituent may be methyl or methoxy. Examples of the substituted aryl group include 2-methylphenyl, 3-methyphenyl, 4-methylphenyl, 4-methoxyphenyl, and 3,5-dimethylphenyl.

The alkyl group represented by R⁵ in general formula (1) may be, but is not limited to, methyl, ethyl, n-propyl, isopropyl, n-butyl, or isobutyl. The methyl, ethyl, n-propyl, and n-butyl groups are more beneficial in terms of high chroma and wide-range color reproduction and for increasing fastness to light.

The aryl group represented by R⁵ in general formula (1) may be, but is not limited to, phenyl. If the aryl group has a substituent, the substituted aryl group may be, for example, 2-methylphenyl or 2-methoxyphenyl.

If R⁵ in general formula (1) represents —N(—R⁶)R⁷, the alkyl groups represented by R⁶ and R⁷ each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

If R⁵ in general formula (1) represents —N(—R⁶)R⁷, the acyl groups represented by R⁶ and R⁷ each may be, but are not limited to, a substituted or unsubstituted alkylcarbonyl group having a carbon number of 2 to 30, or a substituted or unsubstituted arylcarbonyl group having a carbon number of 7 to 30. More specifically, examples thereof include acetyl, propionyl, pivaloyl, benzoyl, and naphthoyl.

If R⁶ and R⁷ of —N(—R⁶)R⁷ bind to each other to form a ring structure, the ring structure may be, but is not limited to, a piperidine ring, a piperazine ring, or a morpholine ring. In this instance, R⁶ and R⁷ are each an atomic group capable of forming such a ring.

If at least one of R⁶ and R⁷ is an alkyl group, satisfactory light fastness can be obtained. In particular, the methyl group is beneficial in terms of high chroma and wide-range color reproduction and for increasing fastness to light.

The compound represented by general formula (1), which is a magenta dye, can be synthesized with reference to the known process disclosed in WO92/19684. The structure represented by general formula (1) has cis-trans isomers, and both are within the scope of the invention.

Examples of the compound represented by general formula (1) include, but are not limited to, the following compounds (1-1) to (1-48):

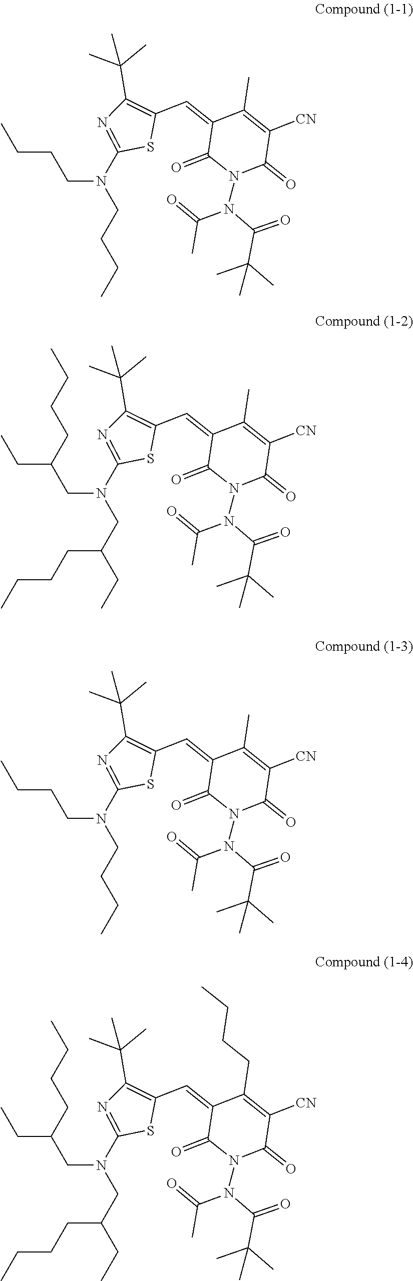

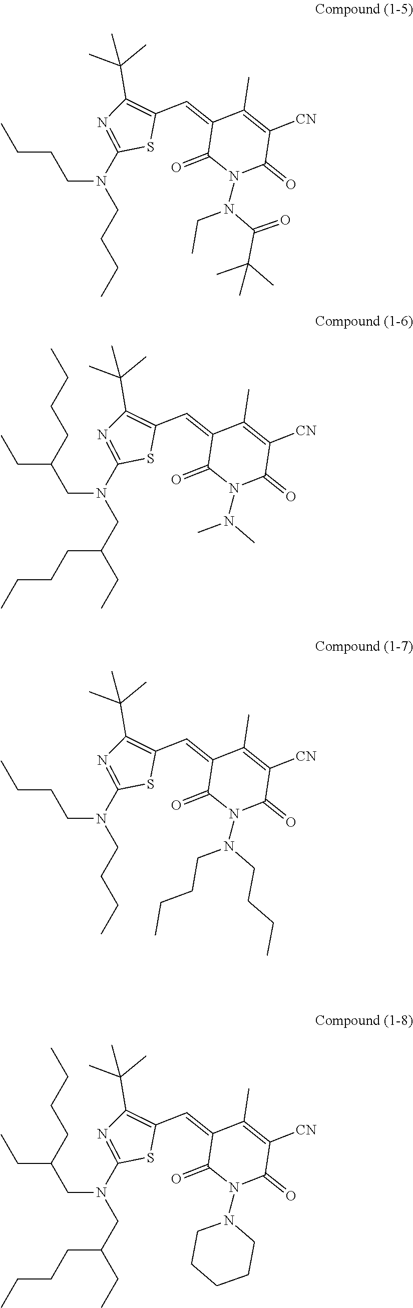

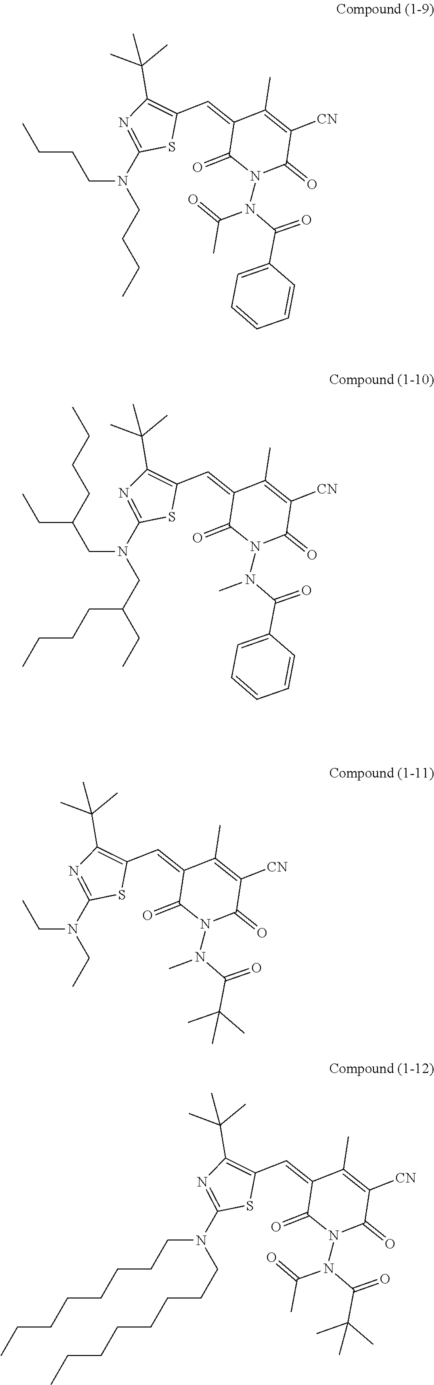

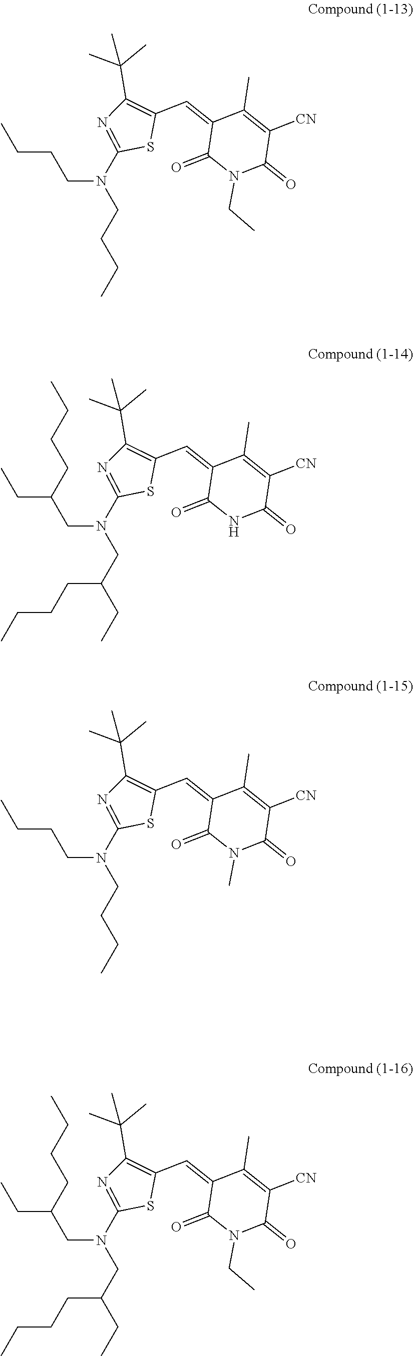

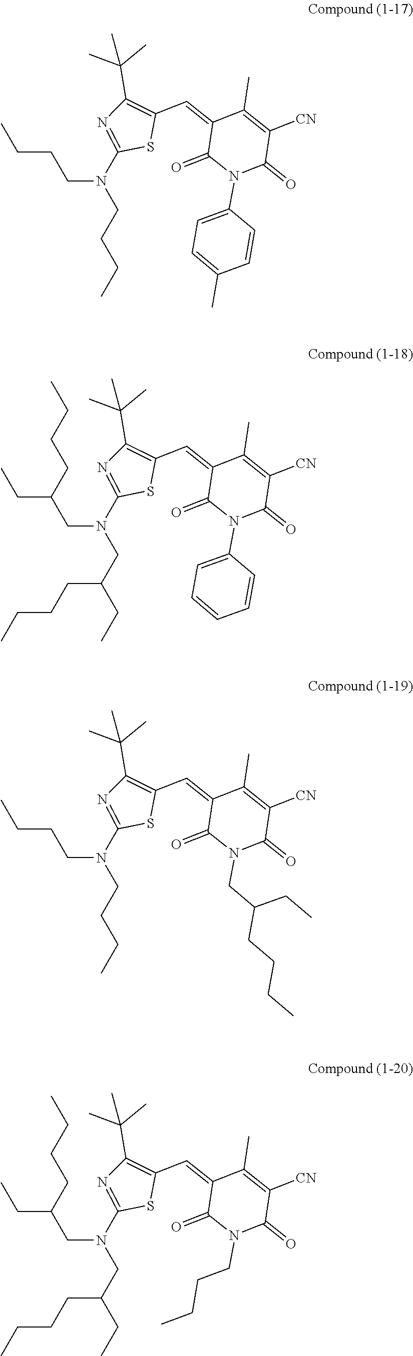

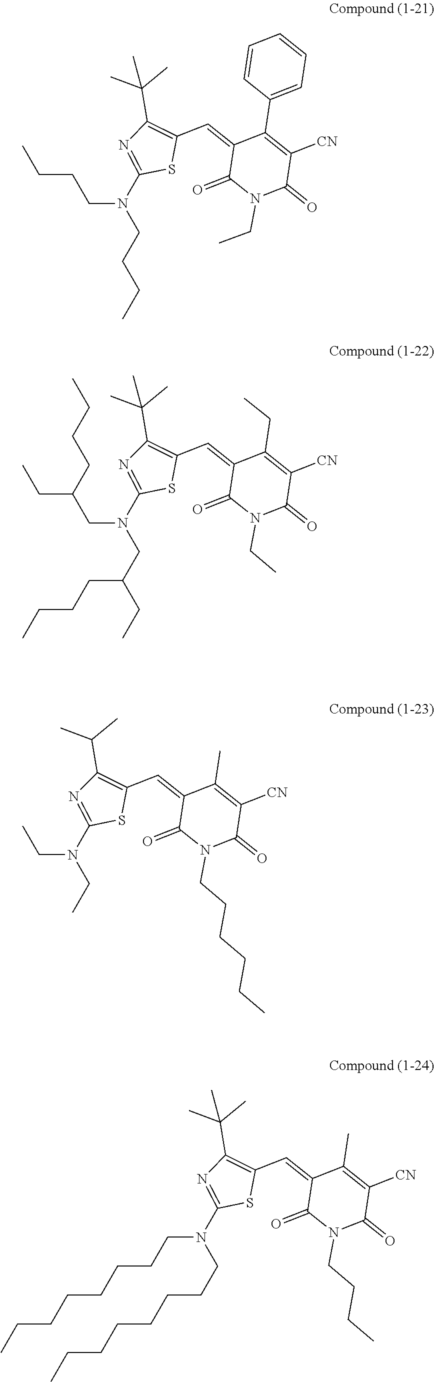

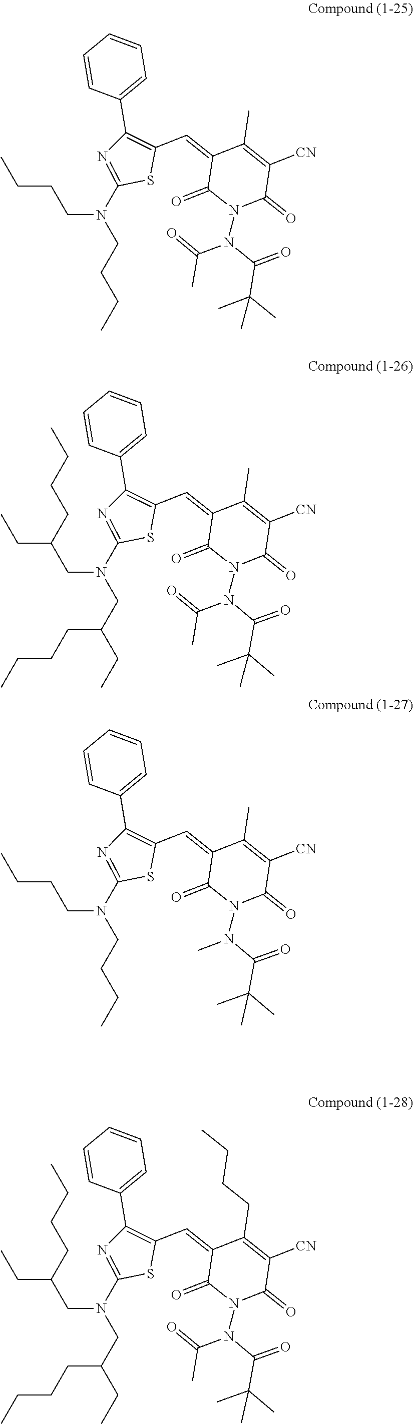

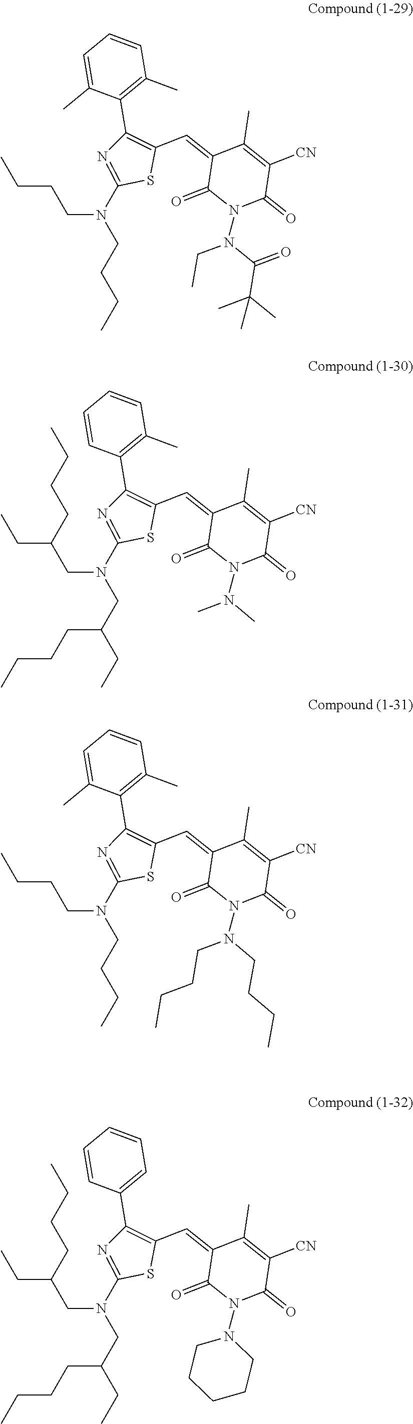

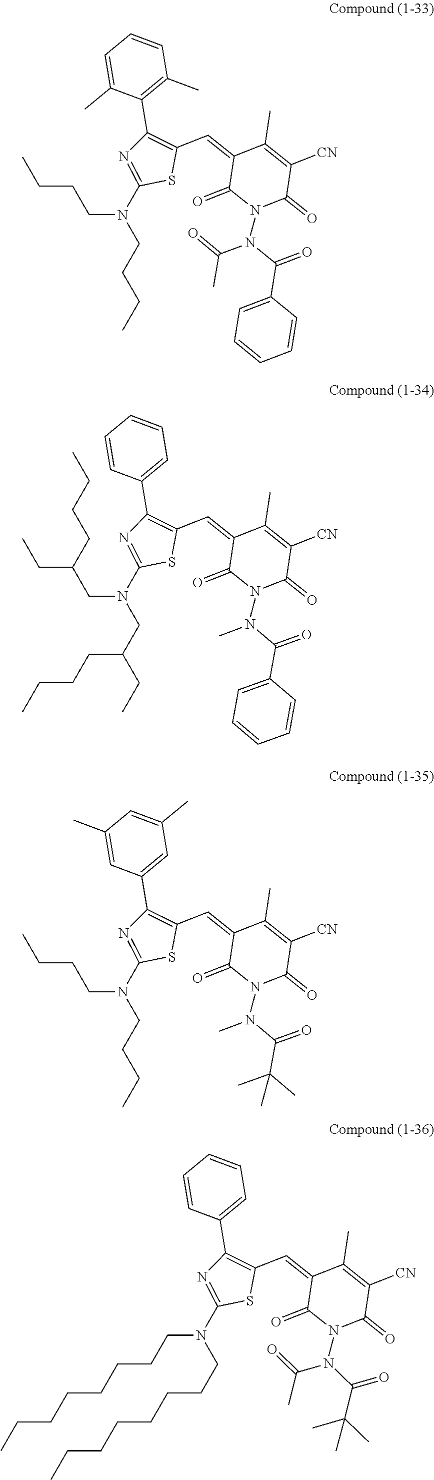

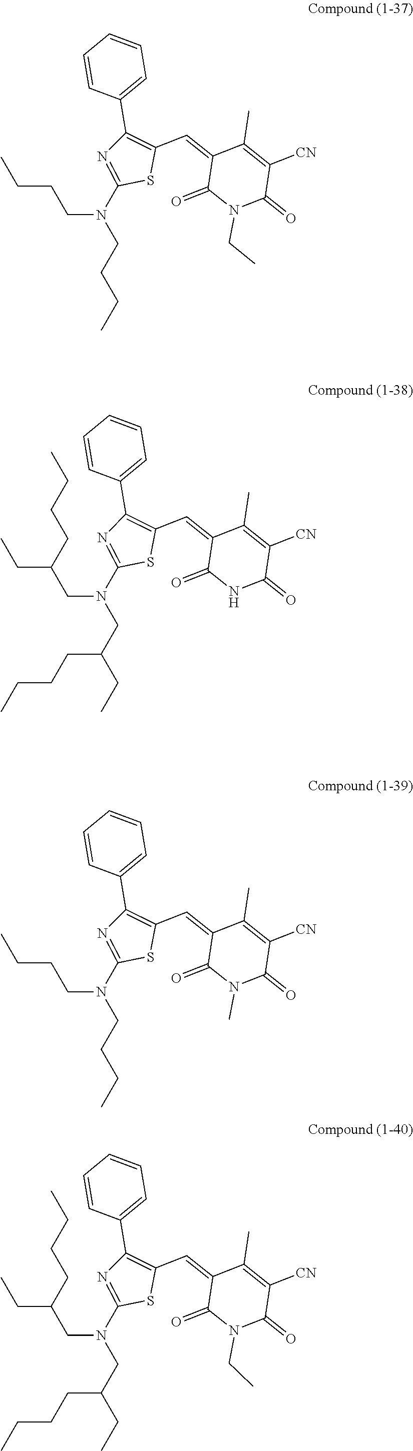

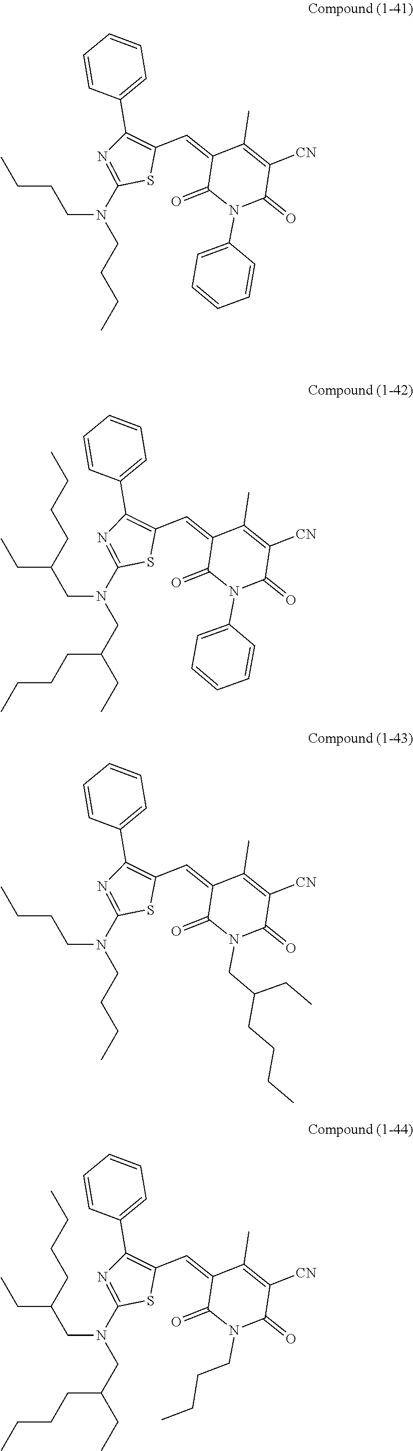

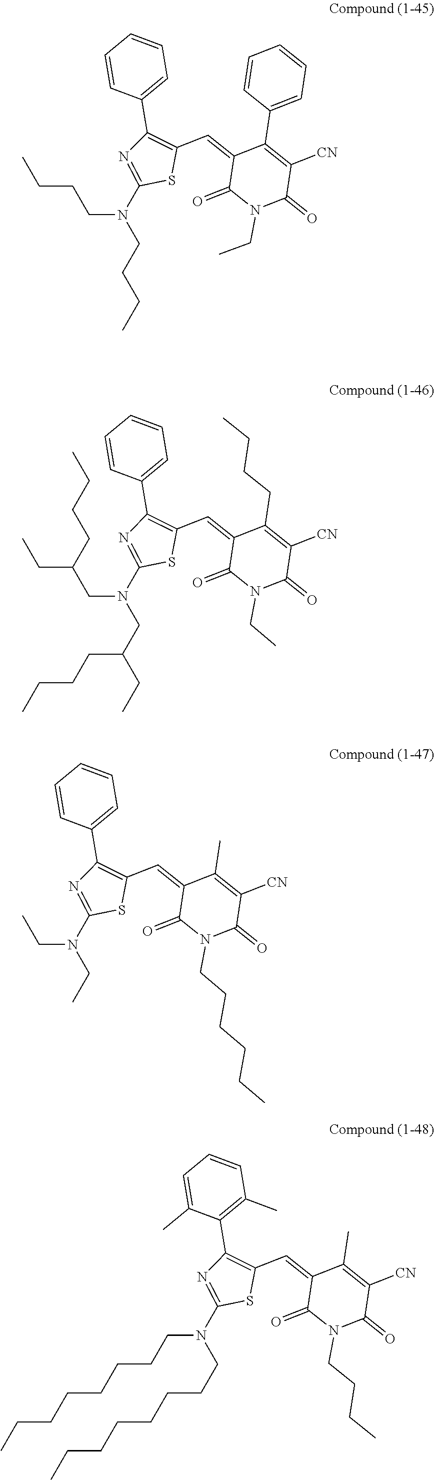

### Yellow Dye

A yellow dye (pyridone azo dye) represented by general formula (6) will now be described.

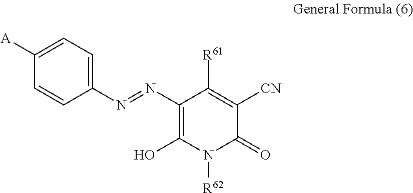

In general formula (6), R⁶¹ and R⁶² each represents an alkyl group, and A represents a group selected from the group consisting of —SO₂N(R⁶³)R⁶⁴, —CON(R⁶³)R⁶⁴, and —COOR⁶³, wherein R⁶³ and R⁶⁴ each independently represent a chemical species selected from the group consisting of a hydrogen atom and alkyl groups.

The compound represented by general formula (6) may be a compound in which R⁶¹ and R⁶² are each an alkyl group; and A is —CON(R⁶³)R⁶⁴, wherein R⁶³ and R⁶⁴ are each independently a chemical species selected from the group consisting of a hydrogen atom and alkyl groups.

The alkyl groups represented by R⁶¹ and R⁶² in general formula (6) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl. Branched alkyl groups are more beneficial in terms of high chroma and wide-range color reproduction and for increasing fastness to light. In particular, the 2-ethylhexyl group is beneficial.

A in general formula (6) represents —SO₂N(R⁶³)R⁶⁴, —CON(R⁶³)R⁶⁴, or —COOR⁶³, and —CON(R⁶³)R⁶⁴ is more beneficial in terms of high chroma and wide-range color reproduction and for increasing fastness to light.

The alkyl groups represented by R⁶³ and R⁶⁴ in general formula (6) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl. The tert-butyl group is more beneficial in terms of high chroma and wide-range color reproduction and for increasing fastness to light.

The compound represented by general formula (6), which is a yellow dye, can be synthesized with reference to the known process disclosed in Japanese Patent Laid-Open No. 2013-209638. The structure represented by general formula (6) has cis-trans isomers, and both are within the scope of the invention.

Examples of the compound represented by general formula (6) include, but are not limited to, the following compounds (6-1) to (6-45):

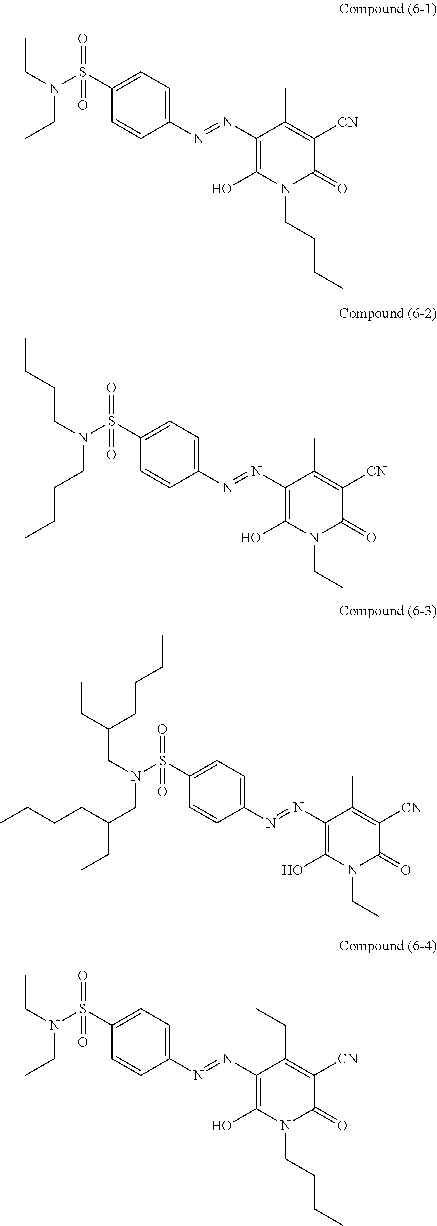

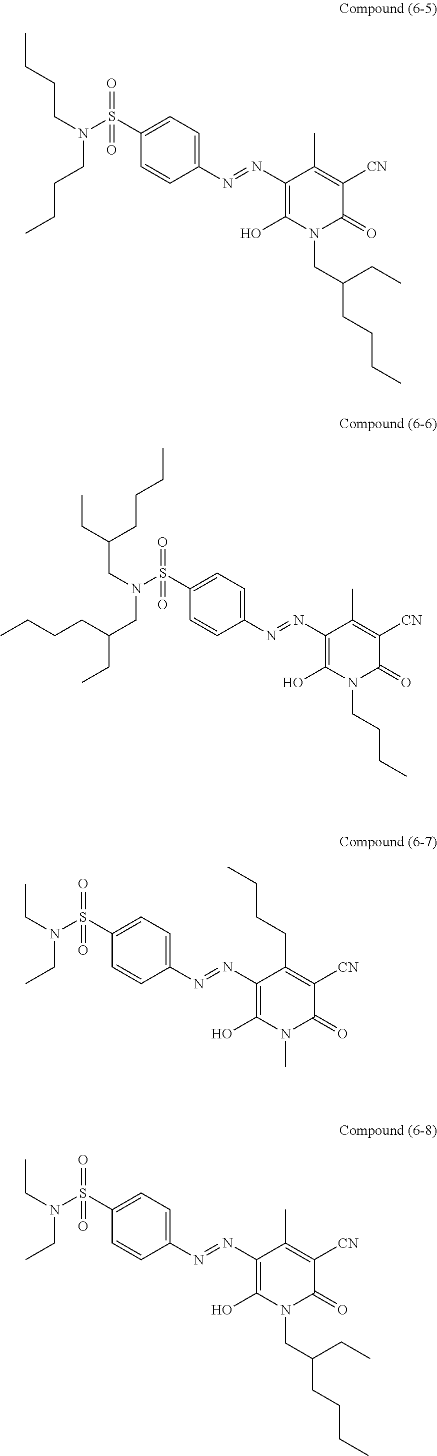

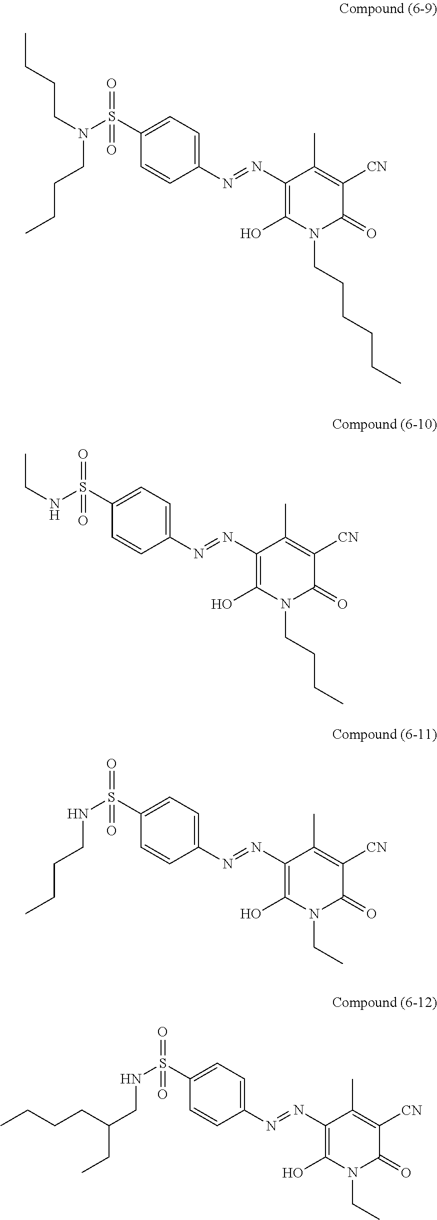

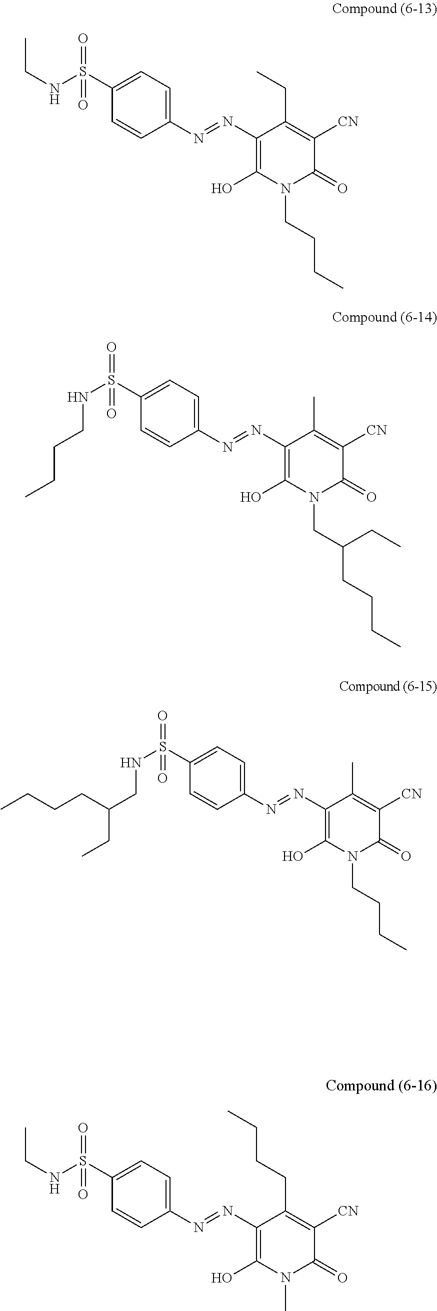

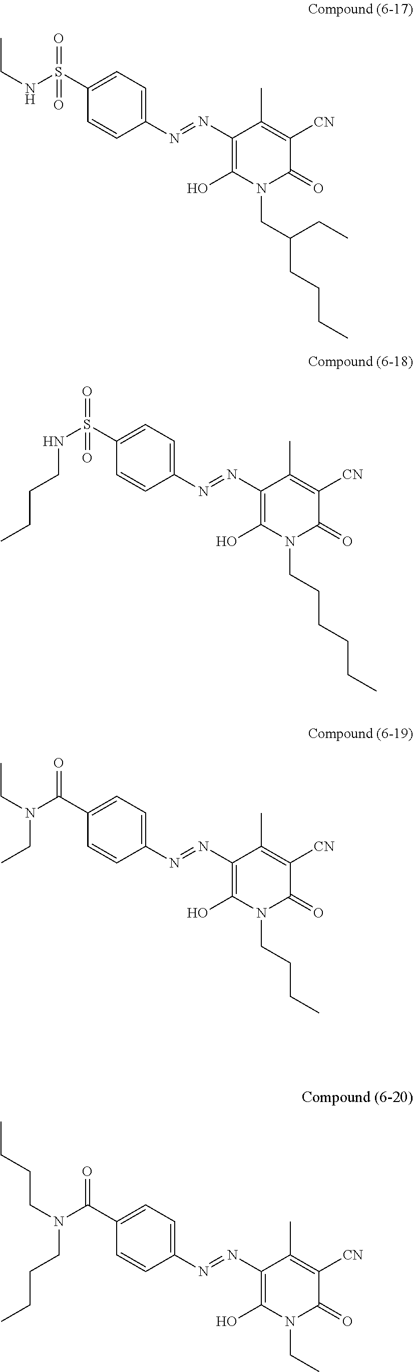

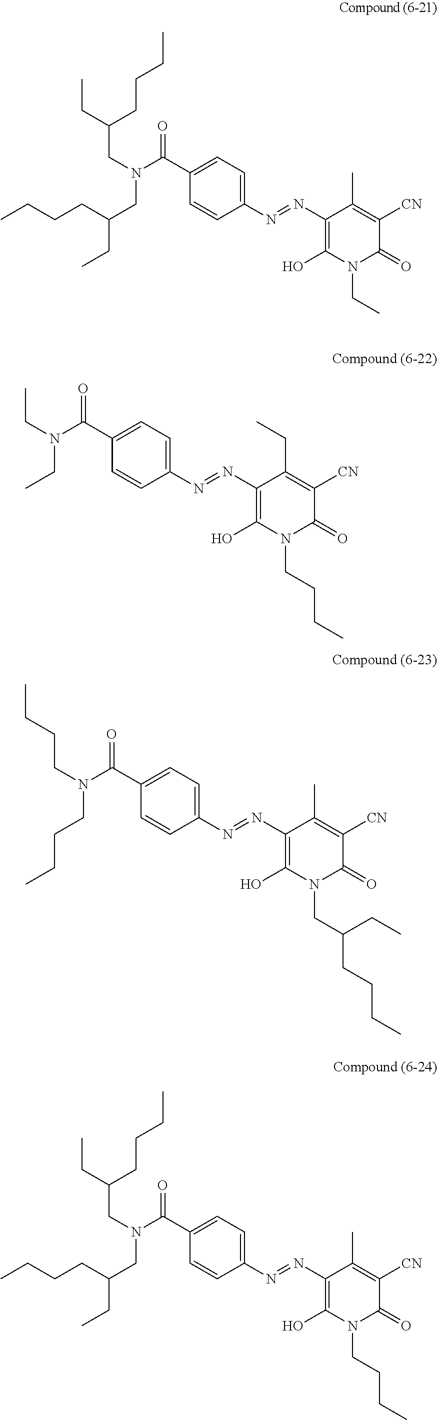

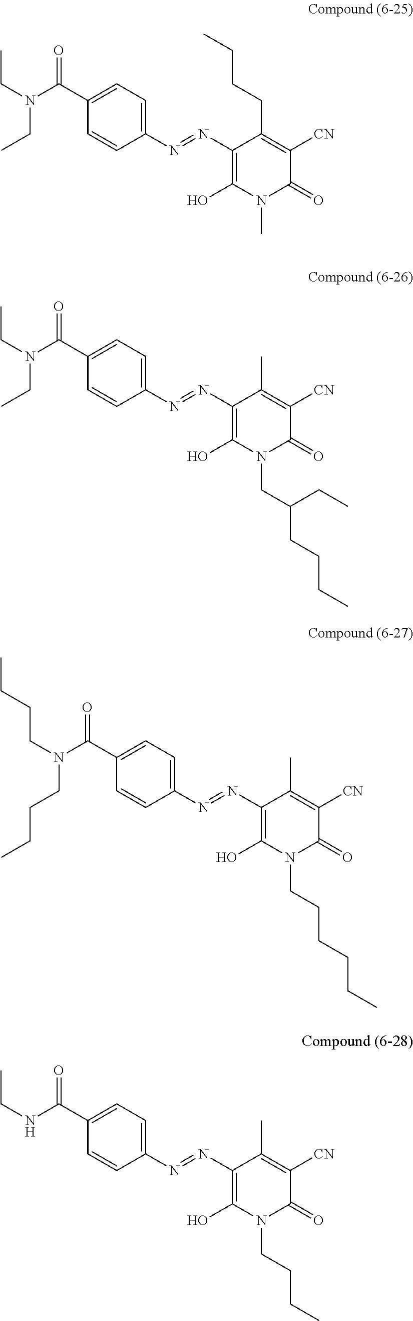

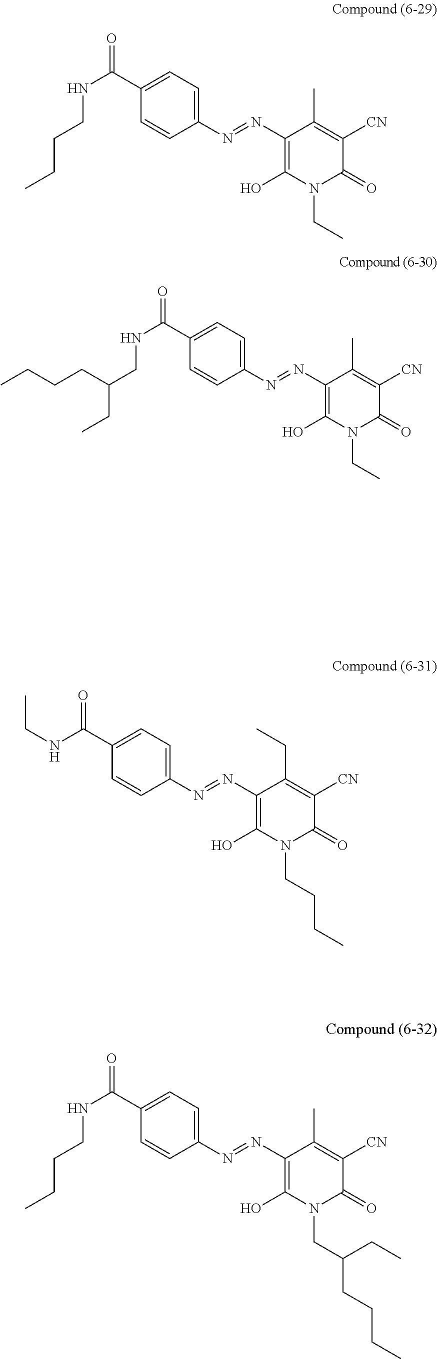

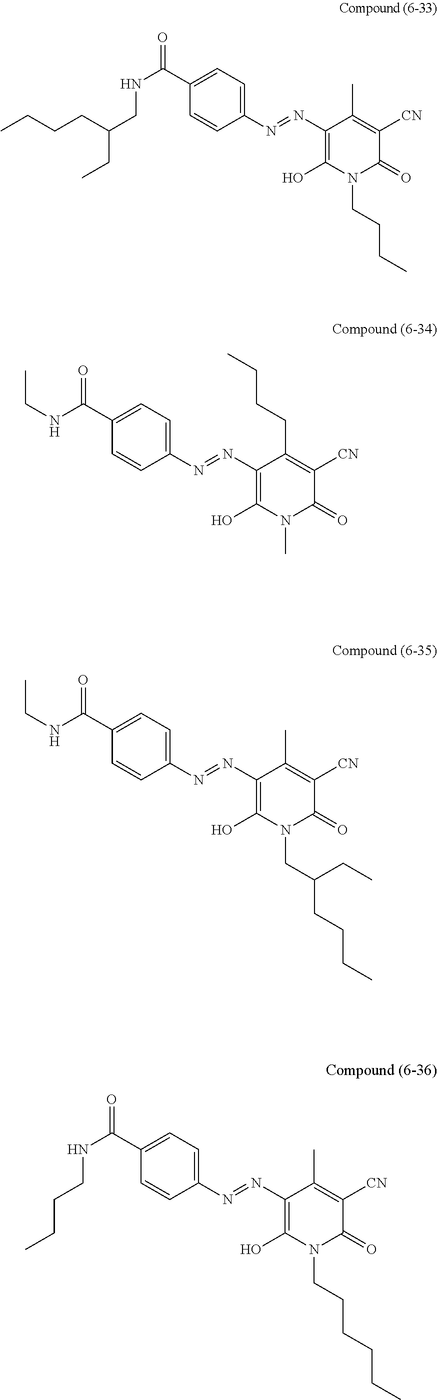

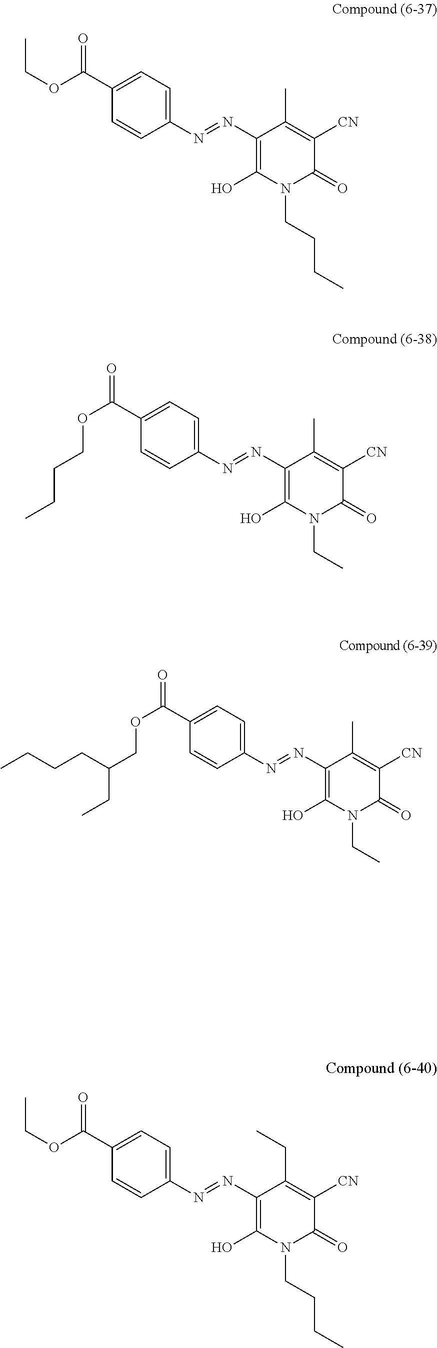

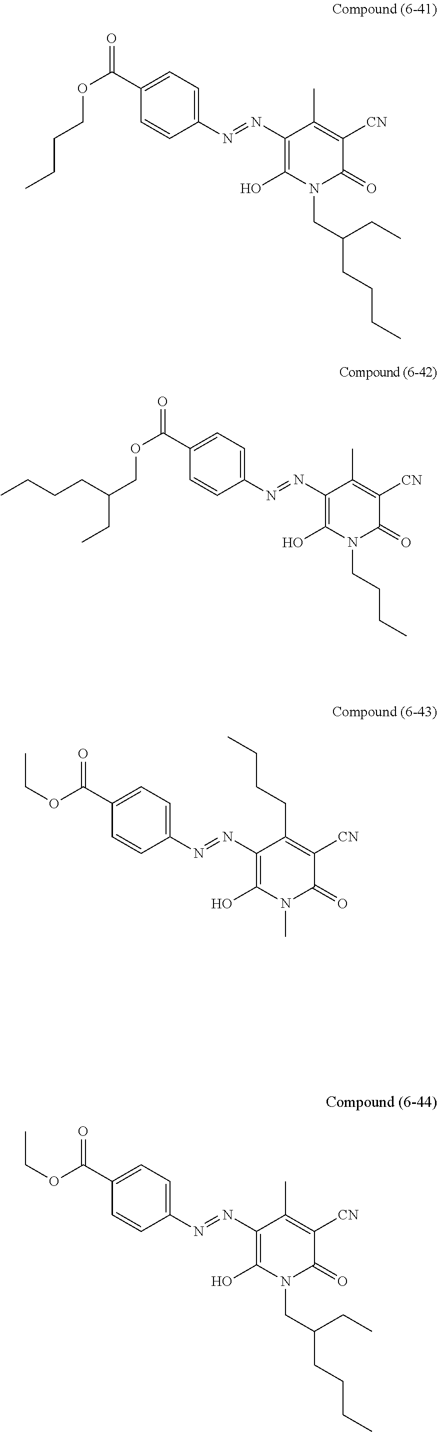

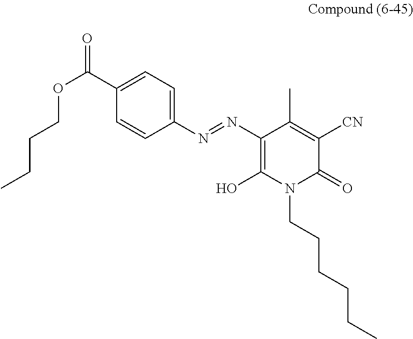

### Ultraviolet Light Absorbent

The ultraviolet light absorbent represented by general formula (2) will now be described.

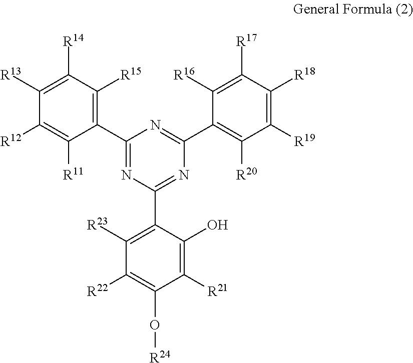

In general formula (2), R¹¹ and R¹⁶ each independently represent a chemical species selected from the group consisting of a hydrogen atom, alkyl groups, alkoxy groups, and a hydroxy group. R¹², R¹⁴, R¹⁵, R¹⁷, R¹⁹, R²⁰, R²¹, R²², and R²³ each independently represent a chemical species selected from the group consisting of a hydrogen atom and alkyl groups. R¹³ and R¹⁸ each independently represent a chemical species selected from the group consisting of a hydrogen atom, alkyl groups, and alkoxy groups. R²⁴ represents a chemical species selected from the group consisting of a hydrogen atom, alkyl groups, and alkyl groups having a hydroxy group.

The compound represented by general formula (2) may be a compound in which R¹¹ and R¹⁶ are each independently a chemical species selected from the group consisting of a hydrogen atom, alkyl groups, and a hydroxy group; R¹², R¹⁴, R¹⁵, R¹⁷, R¹⁹, R²⁰, R²¹, R²², and R²³ are each independently a chemical species selected from the group consisting of a hydrogen atom and alkyl groups; R¹³ and R¹⁸ are each an alkyl group; and R²⁴ is an alkyl group.

The alkyl groups represented by R¹¹ and R¹⁶ in general formula (2) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkoxy groups represented by R¹¹ and R¹⁶ in general formula (2) each may be, but are not limited to, a linear, branched, or cyclic primary to tertiary alkoxy group having a carbon number of 1 to 20. Examples of such an alkoxy group include methoxy, ethoxy, n-propoxy, isopropoxy, n-butoxy, sec-butoxy, and tert-butoxy.

The alkyl groups represented by R¹², R¹⁴, R¹⁵, R¹⁷, R¹⁹, R²⁰, R²¹, R²², and R²³ in general formula (2) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkyl groups represented by R¹³ and R¹⁸ in general formula (2) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkoxy groups represented by R¹³ and R¹⁸ in general formula (2) each may be, but are not limited to, a linear, branched, or cyclic primary to tertiary alkoxy group having a carbon number of 1 to 20. Examples of such an alkoxy group include methoxy, ethoxy, n-propoxy, isopropoxy, n-butoxy, sec-butoxy, and tert-butoxy.

The alkyl group represented by R²⁴ in general formula (2) may be, but is not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The compound having the structure represented by general formula (2) can be synthesized with reference to the known process disclosed in Japanese Patent No. 4104185. This compound is commercially available.

Examples of the compound represented by general formula (2) include, but are not limited to, the following compounds (2-1) to (2-17):

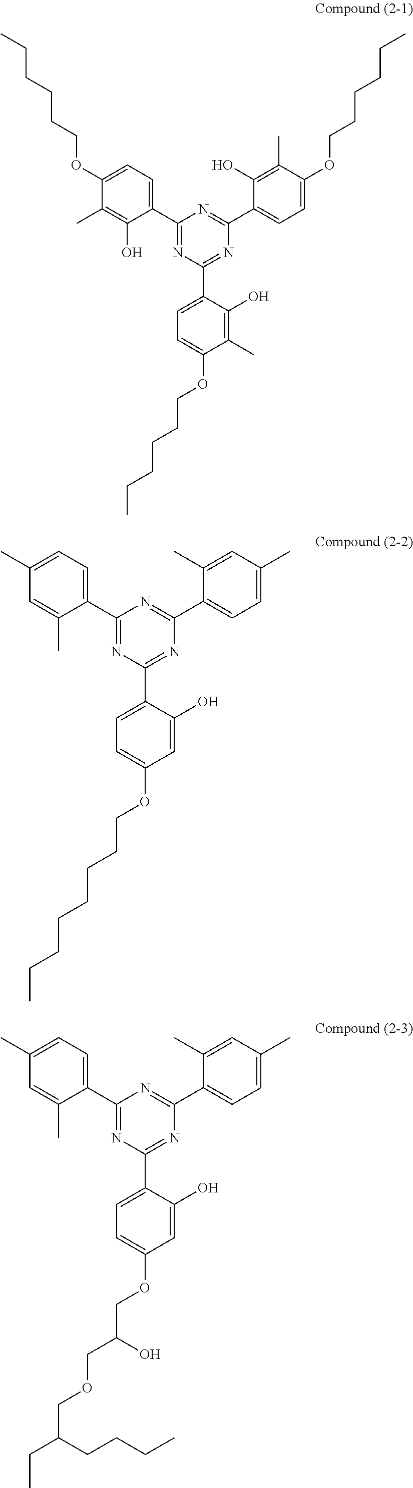

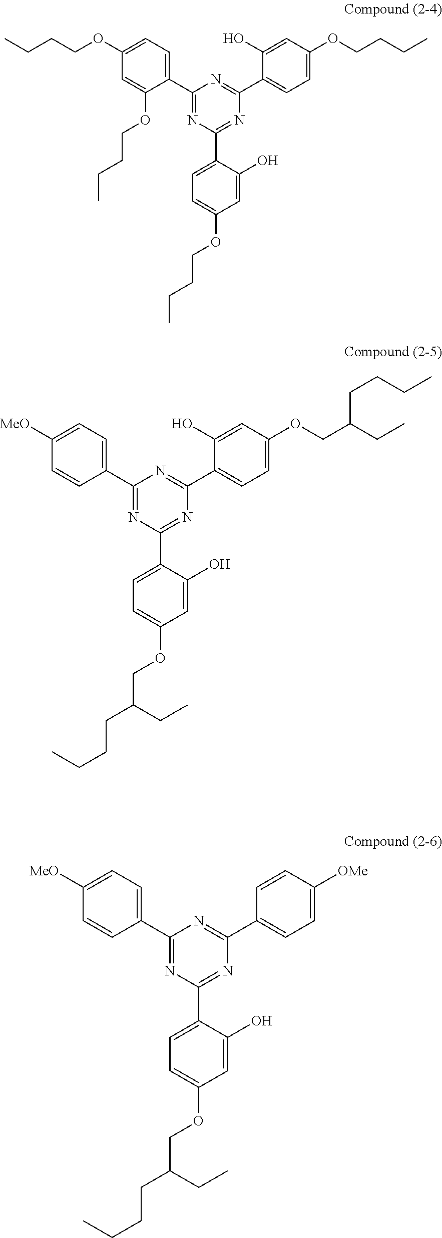

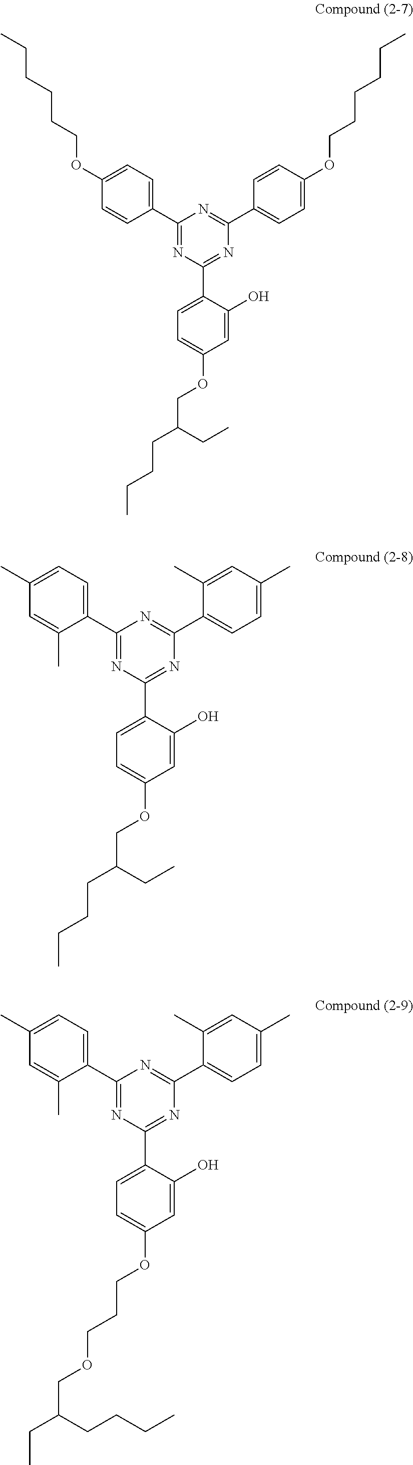

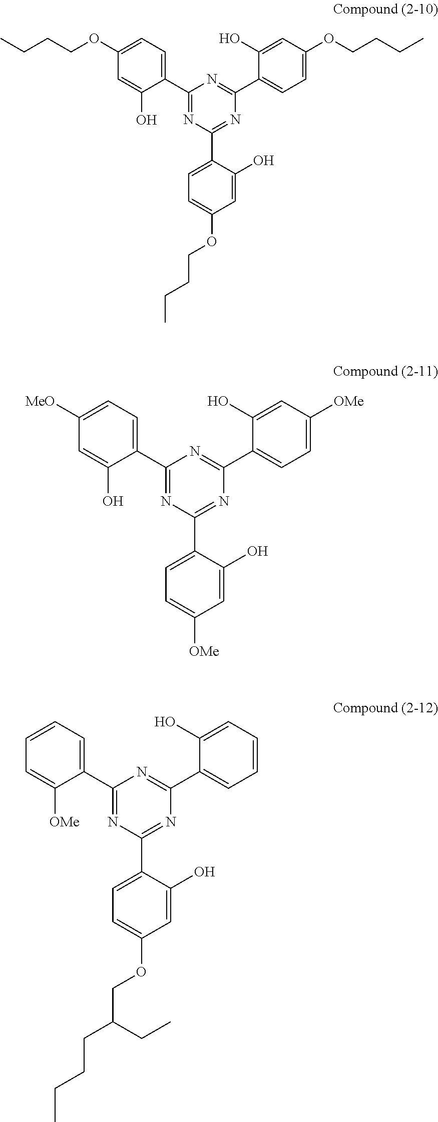

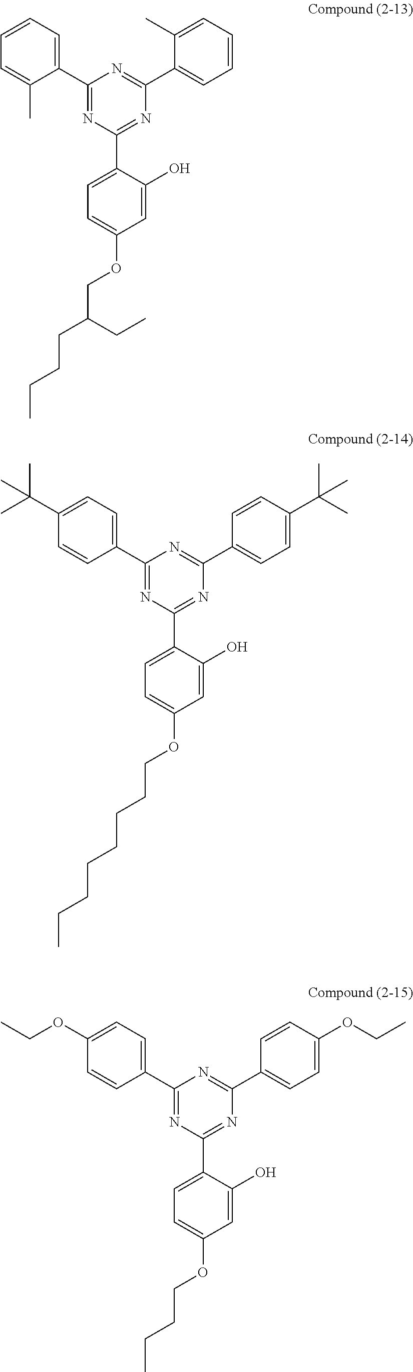

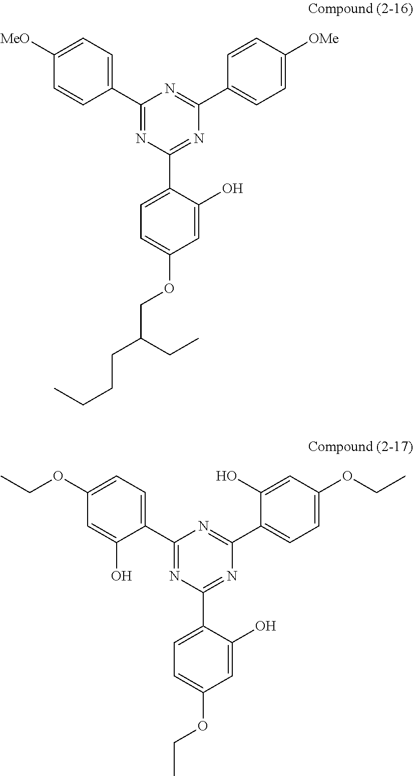

The ultraviolet light absorbent represented by general formula (3) will now be described.

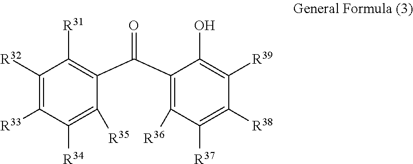

In general formula (3), R³¹ represents a chemical species selected from the group consisting of a hydrogen atom, alkyl groups, and a hydroxy group. R³², R³⁴, R³⁵, R³⁶, R³⁷, and R³⁹ each independently represent a chemical species selected from the group consisting of a hydrogen atom and alkyl groups. R³³ and R³⁸ each independently represent a chemical species selected from the group consisting of a hydrogen atom, a hydroxy group, and alkoxy groups.

The compound represented by general formula (3) may be a compound in which R³¹ is a hydrogen atom or a hydroxy group; R³², R³⁴, R³⁵, R³⁶, R³⁷, and R³⁹ are each independently a hydrogen atom; and R³³ and R³⁸ are each independently chemical species selected from the group consisting of a hydrogen atom and alkyl groups.

The alkyl group represented by R³¹ in general formula (3) may be, but is not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkyl groups represented by R³², R³⁴, R³⁵, R³⁶, R³⁷, and R³⁹ in general formula (3) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkoxy groups represented by R³³ and R³⁸ in general formula (3) each may be, but are not limited to, a linear, branched, or cyclic primary to tertiary alkoxy group having a carbon number of 1 to 20. Examples of such an alkoxy group include methoxy, ethoxy, n-propoxy, isopropoxy, n-butoxy, sec-butoxy, and tert-butoxy.

The compound having the structure represented by general formula (3) can be synthesized by referring to a known process. This compound is commercially available.

Examples of the compound represented by general formula (3) include, but are not limited to, the following compounds (3-1) to (3-8):

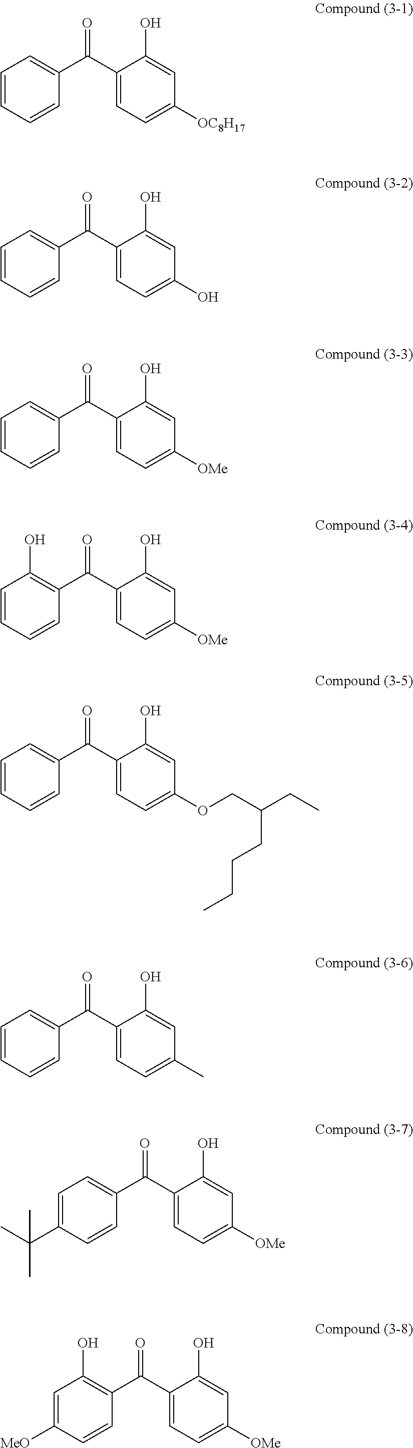

The ultraviolet light absorbent represented by general formula (4) will now be described.

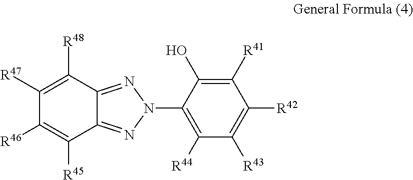

In general formula (4), R⁴¹ and R⁴³ each independently represent a chemical species selected from the group consisting of a hydrogen atom, alkyl groups, unsubstituted aryl groups, and substituted aryl groups, and R⁴² and R⁴⁴ to R⁴⁸ each independently represent a chemical species selected from the group consisting of a hydrogen atom and alkyl groups.

The compound represented by general formula (4) may be a compound in which R⁴¹ and R⁴³ are each independently a chemical species selected from the group consisting of a hydrogen atom and alkyl groups; and R⁴² and R⁴⁴ to R⁴⁸ are each a hydrogen atom.

The alkyl groups represented by R⁴¹ and R⁴³ in general formula (4) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The aryl groups represented by R⁴¹ and R⁴³ in general formula (4) may be, but is not limited to, phenyl. If the aryl group has a substituent, the substituent may be methyl, ethyl, or methoxy. Examples of the substituted aryl group include 2-methylphenyl, 3-methyphenyl, 4-methylphenyl, 2,6-dimethylphenyl, 2,6-diethylphenyl, 2,4,6-trimethylphenyl, 2,4,6-triethylphenyl, 3-methoxyphenyl, and 2,6-dimethoxyphenyl.

The alkyl groups represented by R⁴² and R⁴⁴ to R⁴⁸ in general formula (4) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The compound having the structure represented by general formula (4) can be synthesized by referring to a known process. This compound is commercially available.

Examples of the compound represented by general formula (4) include, but are not limited to, the following compounds (4-1) to (4-8):

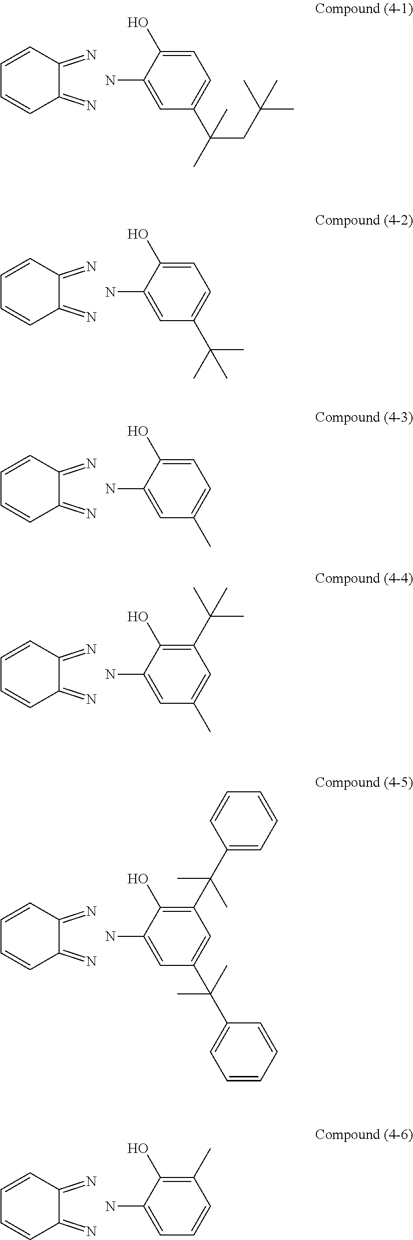

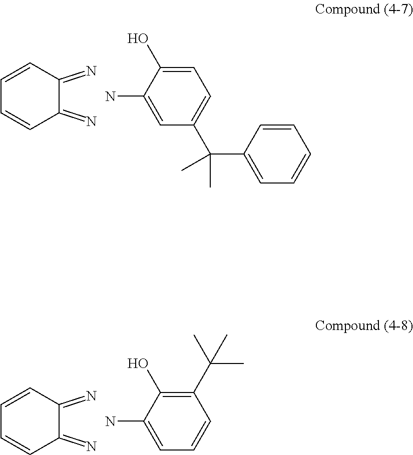

The ultraviolet light absorbent represented by general formula (5) will now be described.

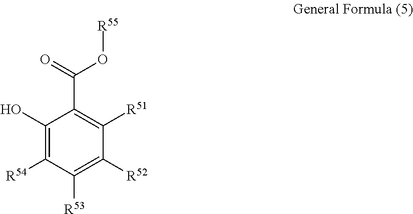

In general formula (5), R⁵¹ to R⁵⁴ each independently represent a chemical species selected from the group consisting of a hydrogen atom and alkyl groups, and R⁵⁵ represents a chemical species selected from the group consisting of alkyl groups, alkyl groups having an aryl group as a substituent, unsubstituted aryl groups, and substituted aryl groups.

The alkyl groups represented by R⁵¹ to R⁵⁴ in general formula (5) each may be, but are not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkyl group represented by R⁵⁵ in general formula (5) may be, but is not limited to, a linear, branched, or cyclic primary to tertiary alkyl group having a carbon number of 1 to 20. More specifically, examples of such an alkyl group include methyl, ethyl, n-propyl, isopropyl, n-butyl, sec-butyl, tert-butyl, octyl, dodecyl, nonadecyl, cyclobutyl, cyclopentyl, cyclohexyl, methylcyclohexyl, 2-ethylpropyl, and 2-ethylhexyl.

The alkyl group having an aryl group and represented by R⁵⁵ in general formula (5) may be, but is not limited to, benzyl.

The aryl group represented by R⁵⁵ in general formula (5) may be, but is not limited to, phenyl. If the aryl group has a substituent, the substituent may be methyl, ethyl, or methoxy. Examples of the substituted aryl group include 2-methylphenyl, 3-methyphenyl, 4-methylphenyl, 2,6-dimethylphenyl, 2,6-diethylphenyl, 2,4,6-trimethylphenyl, 2,4,6-triethylphenyl, 3-methoxyphenyl, and 2,6-dimethoxyphenyl.

The compound having the structure represented by general formula (5) can be synthesized by referring to a known process. This compound is commercially available.

Examples of the compound represented by general formula (5) include, but are not limited to, the following compounds (5-1) to (5-8):

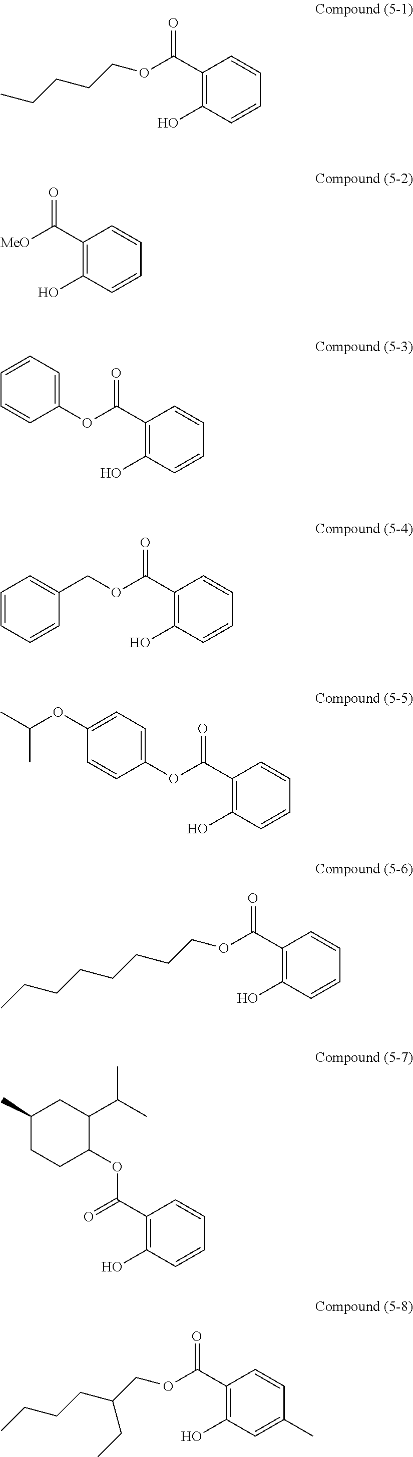

Mixture Containing Compound Represented by One of General Formulas (1) and (6), and at Least One Compound Selected from the Compounds Represented by General Formulas (2) to (5)

It has not clearly been explained why light fastness can significantly be increased by a combination of the compound represented by one of general formulas (1) and (6) with at least one compound selected from the compounds represented by general formulas (2) to (5). However, the compounds represented by general formulas (1) and (6) are dyes that can increase light fastness compared with other dyes when light in the ultraviolet region of 380 nm or less is blocked. It is therefore important to absorb and deactivate the light of 380 nm or less that can fade the color of the compounds of general formulas (1) and (6). Accordingly, it is important that the compounds of general formulas (2) to (5) can absorb light having a wavelength of 380 nm or less and have a structure including a hydrogen bond.

The proportion of one or more compounds of general formulas (2) to (5) may be 50 parts by mass to 200 parts by mass relative to 100 parts by mass of the compound of general formula (1) or (6). In this range, light fastness can be satisfactorily improved.

The mixture of the present embodiment may be used singly or in combination with any other known dye or pigment for adjusting the color.

If a compound represented by general formula (1) is used, magenta pigments that can be combined include, but are not limited to, C. I. Pigment Reds 101, 104, 112, 122, 150, 170, 176, 242, 254, and 269 and colorants classified as derivatives of these pigments. If a compound represented by general formula (6) is used, yellow pigments that can be combined include, but are not limited to, C. I. Pigment Yellows 12, 14, 34, 53, 74, 83, 138, 150, 155, 180, and 185 and colorants classified as derivatives of these pigments. One of these pigments may be used, or two or more of the pigments may be mixed.

The mixture of the present embodiment may be in any form as long as the compound of general formula (1) or (6) and one or more compounds of general formulas (2) to (5) are mixed. For example, the mixture may be in the form of dispersion like ink in which the dye and the ultraviolet light absorbent are dispersed in a dispersion medium, such as water, an organic solvent, or a mixture thereof. Alternatively, the mixture may be in the form of dispersion like toner in which the dye and the ultraviolet light absorbent are dispersed in a resin.

### Toner

The use of a toner containing a compound (dye) represented by general formula (1) or (6), and at least one compound (ultraviolet light absorbent) selected from the compounds represented by general formulas (2) to (5) allows the formation of images whose color can be kept clear for a long time.

In general, a toner contains a binder resin and a colorant, and may optionally contain a release agent, a charge control agent, and an external additive.

The proportion of the compound represented by general formula (1) or (6) may be 1 part by mass to 30 parts by mass relative to 100 parts by mass of the binder resin. The proportion of one or more compounds of general formulas (2) to (5) may be 50 parts by mass to 200 parts by mass relative to 100 parts by mass of the compound of general formula (1) or (6).

### Binder Resin

The binder resin may be selected from among known resins used in toners, such as styrene acrylic resin, polyester, epoxy resin, polyurethane, and olefin resin. These resins may have a crosslinked structure to increase the mechanical strength or adjust the molecular weight distribution.

### Release Agent (Wax)

The release agent may be selected from among known release agents used in toners. Examples of the known waxes include hydrocarbon waxes, such as paraffin wax, microcrystalline wax, Fischer-Tropsch wax, polyethylene, and polypropylene; ester waxes, such as carnauba wax and synthesized ester waxes; and amide waxes. The proportion of the release agent may be in the range of 2.5 parts by mass to 15 parts by mass relative to 100 parts by mass of the binder resin. Beneficially, it is in the range of 3 parts by mass to 10 parts by mass. When it is in the range of 2.5 parts by mass to 15 parts by mass, satisfactory fixity can be imparted.

The melting point of the release agent may be in the range of 50° C. to 200° C., such as 55° C. to 150° C. The melting point of a material mentioned herein is the endothermic peak temperature in a differential scanning calorimetry (DSC) curve of the material measured in accordance with ASTM D3418-82.

### Charge Control Agent

The charge control agent may be selected from known charge control agents.

For controlling the toner to be negatively chargeable, the charge controlling agent may be selected from among homopolymers or copolymers including a sulfo group or a sulfonate or sulfonic acid ester group; salicylic acid derivatives and metal complexes thereof; monoazo metal compounds; acetyl acetone metal compounds; aromatic oxycarboxylic acids, aromatic monocarboxylic acids, and aromatic polycarboxylic acids and metal salts, anhydrides, and esters of those carboxylic acids; aromatic monocarboxylic or polycarboxylic acids and metal salts, anhydrides and esters thereof; phenol derivatives, such as bisphenols; urea derivatives; metal-containing naphthoic acid-based compounds; boron compounds; quaternary ammonium salts; and calixarene.

For controlling the toner to be positively chargeable, the charge controlling agent may be selected from among nigrosine and fatty acid metal salt-modified nigrosine compounds; guanidine compounds; imidazole compounds; quaternary ammonium salts, such as tributylbenzylammonium-1-hydroxy-4-naphthsulfonates and tetrabutylammonium tetrafluoroborate; onium salts similar to quaternary ammonium salts, such as phosphonium salts, and chelate pigments of onium salts; triphenylmethane dye and lake pigments thereof (prepared using a lake-forming agent, such as phosphotungstic acid, phosphomolybdic acid, phosphotungsten molybdic acid, tannic acid, lauric acid, gallic acid, ferricyanide, or ferrocyanide); higher fatty acid metal salts; diorganotin oxides, such as dibutyltin oxide, dioctyltin oxide, and dicyclohexyltin oxide; and diorganotin borates, such as dibutyltin borate, dioctyltin borate, and dicyclohexyltin borate, and resin-based charge controlling agents.

### External Additive

The toner may further contain an inorganic fine powder as an external additive for increasing the fluidity. The inorganic fine powder may a fine powder of silica, titanium oxide, alumina, or a complex oxide thereof. The particles of the fine powder may be surface-treated with a hydrophobizing agent.

### Process for Manufacturing Toner

Toner particles of the toner of the present disclosure may be produced by a pulverization method, a suspension polymerization method, a suspension granulation method, an emulsion polymerization method, or an emulsion aggregation method. It may be beneficial that the toner particles are produced by a method performing granulation in an aqueous medium, such as the suspension polymerization method or the suspension granulation method.

Such toner particles can be applied to a liquid developer used for liquid development.

### Physical Properties of Toner

The toner of the present disclosure may have a weight-average particle size D4 of 4.0 μm to 9.0 μm. The ratio (D4/D1) of the weight-average particle size D4 to the number-average particle size D1 may be 1.35 or less. Beneficially, the weight-average particle size D4 is in the range of 4.9 μm to 7.5 μm and the D4/D1 ratio is 1.30 or less. The toner having a weight-average particle size of 4.0 μm or more is stable in chargeability. Accordingly, deterioration of images, such as fogging and development streaks, caused by continuous operation (persistence of operation) for developing many printing sheets can be reduced. Also, when the weight average particle size of the toner is 8.0 μm or less, the reproducibility of half tone image portions is improved. When the D4/D1 ratio is 1.35 or less, fogging is reduced and transferability is improved. In addition, the variation in thickness of thin lines or the like is reduced.

The number-average particle size D1 and the weight-average particle size D4 can be determined by particle size distribution analysis using Coulter method. In the Examples described later, these particle sizes were measured by using Coulter Counter TA-II or Coulter Multisizer II (manufactured by Beckman Coulter) in accordance with the operation manual of the measuring apparatus. In this instance, about 1% sodium chloride aqueous solution prepared using first-class grade sodium chloride may be used as the electrolyte. Alternatively, ISOTON-II (manufactured by Beckman Coulter) may be used. Specifically, 0.1 mL to 5 mL of surfactant (for example, alkylbenzene sulfonate) is added as a dispersant into 100 mL to 150 mL of electrolyte, and then, 2 mg to 20 mg of a sample (toner particles) to be measured is further added. Then, the sample in the electrolyte is subjected to dispersion for about 1 to 3 minutes with an ultrasonic disperser. The resulting dispersion liquid is subjected to measurement for the volume and the number of toner particles having a particle size of 2.00 μm or more by using the above-described measurement apparatus with a 100 μm aperture, and the volume distribution and the number distribution of toner particles are determined from the measurement results. Thus, the number-average particle size D1, weight-average particle size D4 and D4/D1 ratio of the toner are determined.

For the measurement are used 13 channels: 2.00 μm to 2.52 μm, 2.52 μm to 3.17 μm, 3.17 μm to 4.00 μm, 4.00 μm to 5.04 μm, 5.04 μm to 6.35 μm, 6.35 μm to 8.00 μm, 8.00 μm to 10.08 μm, 10.08 μm to 12.70 μm, 12.70 μm to 16.00 μm, 16.00 μm to 20.20 μm, 20.20 μm to 25.40 μm, 25.40 μm to 32.00 μm, and 32.00 μm to 40.30 μm. For each channel, the median is the representative value of the channel.

The average circularity of the toner particles measured with a flow particle image analyzer may be in the range of 0.930 to 0.995, and is beneficially in the range of 0.960 to 0.990 from the viewpoint of improving the transferability of the toner.

### Dye Dispersion (Dispersion)

A dye dispersion contains a dispersion medium containing at least one of water and an organic solvent, a compound represented by one of general formulas (1) and (6), and at least one compound selected from the compounds represented by general formulas (2) to (5). These compounds are dispersed in the dispersion medium.

The dye dispersion can be used for various purposes and may be used as an ink. If the dispersion medium is a polymerizable monomer, the dye dispersion may be used for manufacturing a suspension-polymerized toner.

In the dye dispersion according to an embodiment of the present disclosure, the proportion of the dye (compound represented by general formula (1) or (6)) may be in the range of 1 part by mass to 30 parts by mass relative to 100 parts by mass of the dispersion medium. Beneficially, it is in the range of 2 parts by mass to 20 parts by mass, such as 3 parts by mass to 15 parts by mass. By controlling the proportion of the dye in such a range, the viscosity of the dye dispersion can be prevented from increasing, and the dye can be sufficiently dispersed. Consequently, the resulting dispersion can exhibit satisfactory tinting strength.

As the proportion of the ultraviolet light absorbent in the dye dispersion is increased, light fastness increases while dispersibility decreases with increasing viscosity. Accordingly, it is beneficially in the range of 1 part by mass to 30 parts by mass relative to 100 parts by mass of the dispersion medium.

The dye may be dispersed in water with an emulsifier. The emulsifier may be a cationic surfactant, an anionic surfactant, or a nonionic surfactant. Examples of the cationic surfactant include dodecylammonium chloride, dodecylammonium bromide, dodecyltrimethylammonium bromide, dodecylpyridinium chloride, dodecylpyridinium bromide, and hexadecyltrimethylammonium bromide. Examples of the anionic surfactant include fatty acid soaps, such as sodium stearate and sodium dodecanoate; and sodium dodecyl sulfate and sodium dodecylbenzene sulfate. Examples of the nonionic surfactant include dodecyl polyoxyethylene ether, hexadecyl polyoxyethylene ether, nonylphenyl polyoxyethylene ether, sorbitan monooleate polyoxyethylene ether, and monodecanoyl sucrose

Exemplary organic solvents that can be used as the dispersion medium include: alcohols, such as methyl alcohol, ethyl alcohol, modified ethyl alcohol, isopropyl alcohol, n-butyl alcohol, isobutyl alcohol, tert-butyl alcohol, sec-butyl alcohol, tert-amyl alcohol, 3-pentanol, octyl alcohol, benzyl alcohol, and cyclohexanol; glycols, such as methyl cellosolve, ethyl cellosolve, diethylene glycol, and diethylene glycol monobutyl ether; ketones, such as acetone, methyl ethyl ketone, and methyl isobutyl ketone; esters, such as ethyl acetate, butyl acetate, ethyl propionate, and cellosolve acetate; hydrocarbons, such as hexane, octane, petroleum ether, cyclohexane, benzene, toluene, and xylene; halogenated hydrocarbons, such as carbon tetrachloride, trichloroethylene, and tetrabromoethane; ethers, such as diethyl ether, dimethyl glycol, trioxane, and tetrahydrofuran; acetals, such as methylal and diethyl acetal; organic acids, such as formic acid, acetic acid, and propionic acid; and sulfur- or nitrogen-containing organic compounds, such as nitrobenzene, dimethylamine, monoethanolamine, pyridine, dimethylsulfoxide, and dimethylformamide.

A polymerizable monomer may be used as the organic solvent. The polymerizable monomer may be an addition-polymerizable or a condensation-polymerizable monomer. Addition-polymerizable monomers are more beneficial. Examples of such a polymerizable monomer include styrene monomers, such as styrene, o-methylstyrene, m-methylstyrene, p-methylstyrene, o-ethylstyrene, m-ethylstyrene, and p-ethylstyrene; acrylate monomers, such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and amide acrylate; methacrylate monomers, such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, and amide methacrylate; olefin monomers, such as ethylene, propylene, butylene, butadiene, isoprene, isobutylene, and cyclohexene; vinyl halides, such as vinyl chloride, vinylidene chloride, vinyl bromide, and vinyl iodide; vinyl esters, such as vinyl acetate, vinyl propionate, and vinyl benzoate; vinyl ethers, such as vinyl methyl ether, vinyl ethyl ether, and vinyl isobutyl ether; and vinyl ketone compounds, such as vinyl methyl ketone, vinyl hexyl ketone, and methyl isopropenyl ketone. These polymerizable monomers may be used singly or in combination. If the dye dispersion is used for a polymerized toner, it is beneficial to use styrene or a styrene-based monomer or a mixture thereof with another polymerizable monomer. Styrene is easy to handle and is therefore beneficial.

The dye dispersion may further contain a resin. The resin that can be used in the dye dispersion is not particularly limited and is selected according to the use of the dye dispersion. Examples of the resin include polystyrene resin, styrene copolymer, polyacrylic acid resin, polymethacrylic acid resin, polyacrylic ester resin, polymethacrylic ester resin, acrylic acid-based copolymer, methacrylic acid-based copolymer, polyester resin, polyvinyl ether resin, polyvinyl methyl ether resin, polyvinyl alcohol resin, and polyvinyl butyral resin. These resins may be used singly or in combination.

### Thermal Transfer Recording Sheet

A thermal transfer recording sheet will now be described.

A thermal transfer recording sheet is used in a thermal transfer recording apparatus and includes a substrate and a coloring material layer, and optionally a transferable protective layer, a heat-resistant lubricative layer, and so forth. In general, the coloring material layer of a thermal transfer recording sheet has yellow layers, magenta layers and cyan layers that are field-sequentially formed on the substrate. The phrase “field-sequentially” expresses a state where sets of a yellow layer, a magenta layer, and a cyan layer are repeatedly formed in a direction in which the substrate sheet is moved. In a thermal transfer recording apparatus, the thermal transfer recording sheet is heated with a heating device, such as a thermal head, in a state where the coloring material layer of the recording sheet lies on a coloring material-receiving layer of an image-receiving sheet. Thus, the coloring materials are transferred from the recording sheet to the image-receiving sheet to form an image.

The coloring material layer of the thermal transfer recording sheet of the present disclosure contains the compound represented by general formula (1) or (6) and at least one ultraviolet light absorbent selected from the compounds represented by general formulas (2) to (5). The coloring material layer containing the compound represented by general formula (1) can be used as a magenta layer, and the coloring material layer containing the compound represented by general formula (6) can be used as a yellow layer.

The proportion of the ultraviolet light(s) selected from the compounds of general formulas (2) to (5) may be 50 parts by mass to 200 parts by mass relative to 100 parts by mass of the compound of general formula (1) or (6). In this range, light fastness can be satisfactorily improved.

### EXAMPLES

The subject matter of the present disclosure will be further described in detail with reference to the following Examples, but is not limited to the disclosed Examples. In the following description, “part(s)” and “%” are on a mass basis unless otherwise specified.

### Preparation of Ink (Dye Dispersion)

Each ink was prepared by mixing 150 parts of the colorant shown in Table 1, 150 parts of the ultraviolet light absorbent shown in Table 1, 350 parts of toluene, 350 parts of ethyl acetate, and 300 parts of 2-butanone.

Comparative Compounds 1 to 4 shown in Table 1 have the following structures:

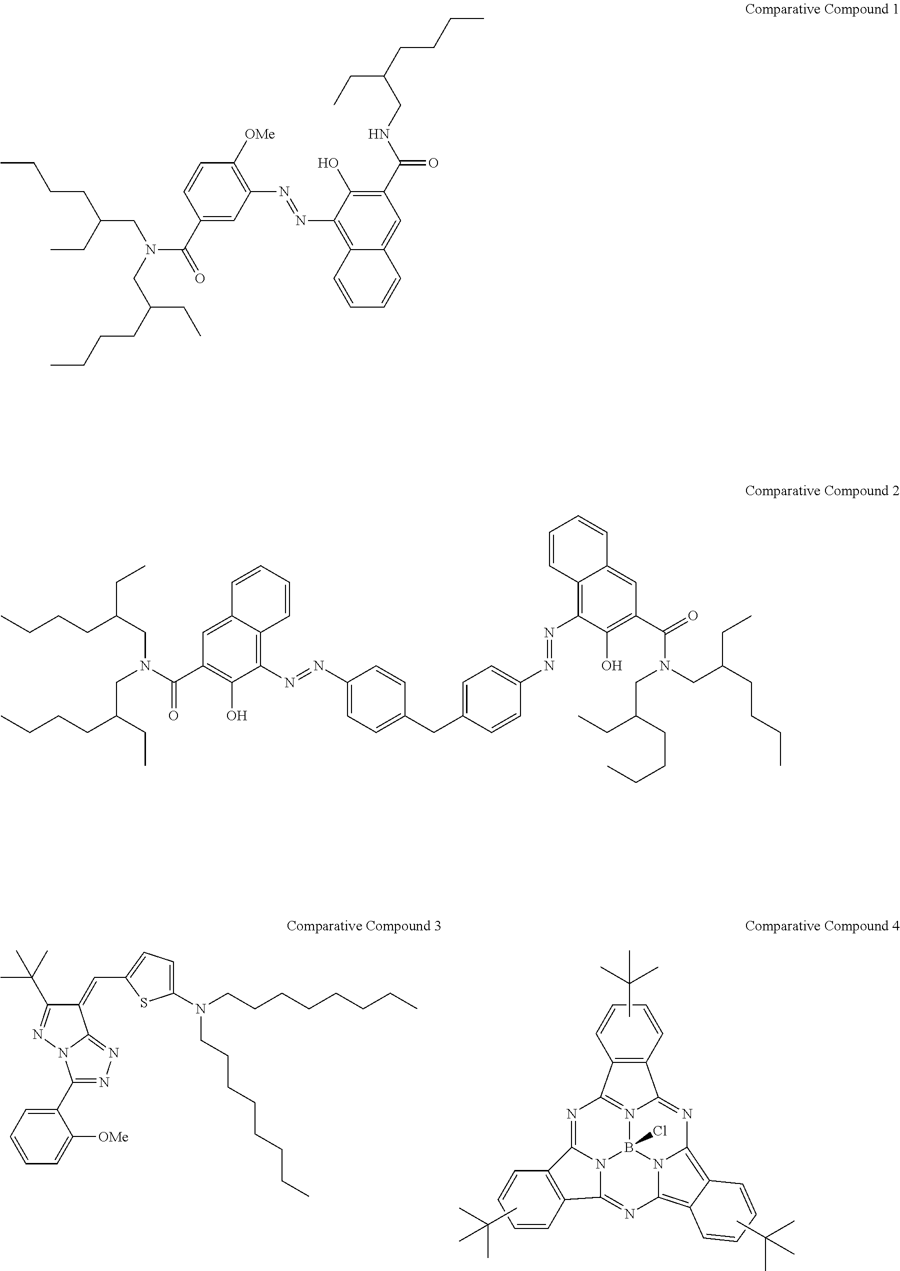

### Examinations

### Preparation of Samples

Each ink was applied onto coverage measurement test paper by bar coating (Bar No. 10) and was then allowed to stand overnight for drying. Thus, image samples were prepared.

### Optical Density Test

The optical density of each of the resulting image samples was measured with a reflection densitometer SpectroLino (manufactured by Gretag Macbeth). The results are shown in Table 1.

### Light Fastness Test

Each image sample was subjected to an exposure test under the conditions of an illuminance of 340 nm at 0.39 W/m², a temperature of 40° C. and a relative humidity of 70% for 50 hours in a xenon test apparatus Atlas Ci 4000 (manufactured by Suga Test Instruments). For each sample, the color parameters (L*, a*, and b*) in the CIE L*a*b* color system were measured before and after the test, and ΔE represented by the following equation was calculated:

ΔE=\sqrt{(a*−a*₀)²+(b*−b*₀)²+(L*−L*₀)²}

In the equation, a₀*, b₀*, and L₀* represent the initial color parameters, and a*, b*, and L* represent the color parameters after exposure. The results are shown in Table 1.

The results were rated according to the following criteria:
A: ΔE<10 (excellent light fastness)
B: 10≦ΔE<20 (good light fastness)
C: 20≦ΔE (poor light fastness)

TABLE 1
Table 1

| | | | Opti- | Light |
|---|---|---|---|---|
| | | Ultraviolet | cal | fastness |
| | | light | den- | ΔE/ |
| | Colorant | absorbent | sity | Rating |
| Example A1 | Compound (1-1) | Compound (2-4) | 2.6 | 3/A |
| Example A2 | Compound (1-6) | Compound (2-5) | 2.6 | 3/A |
| Example A3 | Compound (1-8) | Compound (2-5) | 2.4 | 3/A |
| Example A4 | Compound (1-10) | Compound (2-5) | 2.7 | 3/A |
| Example A5 | Compound (1-16) | Compound (2-5) | 2.7 | 4/A |
| Example A6 | Compound (1-25) | Compound (2-5) | 2.3 | 3/A |
| Example A7 | Compound (1-46) | Compound (3-3) | 2.4 | 9/A |
| Example A8 | Compound (1-1) | Compound (4-3) | 2.6 | 8/A |
| Example A9 | Compound (1-10) | Compound (4-2) | 2.7 | 9/A |
| Example A10 | Compound (1-16) | Compound (2-7) | 2.7 | 5/A |
| Example A11 | Compound (1-16) | Compound (3-3) | 2.7 | 8/A |
| Example A12 | Compound (1-16) | Compound (4-2) | 2.7 | 8/A |
| Comparative | Compound (1-1) | — | 2.6 | 47/C |
| Example A1 | | | | |
| Comparative | Compound (1-6) | — | 2.6 | 28/C |
| Example A2 | | | | |
| Comparative | Compound (1-8) | — | 2.4 | 81/C |
| Example A3 | | | | |
| Comparative | Compound (1-10) | — | 2.7 | 50/C |
| Example A4 | | | | |
| Comparative | Compound (1-16) | — | 2.7 | 84/C |
| Example A5 | | | | |
| Comparative | Compound (1-25) | — | 2.4 | 15/B |
| Example A6 | | | | |
| Comparative | Compound (1-46) | — | 2.4 | 36/C |
| Example A7 | | | | |
| Comparative | Comparative | Compound (2-5) | 2.3 | 50/C |
| Example A8 | Compound 1 | | | |
| Comparative | Comparative | Compound (2-5) | 1.8 | 33/C |
| Example A9 | Compound 2 | | | |
| Comparative | Comparative | Compound (3-3) | 3.1 | 126/C |
| Example A10 | Compound 3 | | | |
| Comparative | Comparative | Compound (4-3) | 2.6 | 101/C |
| Example A11 | Compound 4 | | | |
| Comparative | Comparative | — | 2.3 | 47/C |
| Example A12 | Compound 1 | | | |
| Comparative | Comparative | — | 1.8 | 15/B |
| Example A13 | Compound 2 | | | |
| Comparative | Comparative | — | 3.1 | 126/C |
| Example A14 | Compound 3 | | | |
| Comparative | Comparative | — | 2.5 | 103/C |
| Example A15 | Compound 4 | | | |

As is clear from the results of Examples A1 to A12 and Comparative Examples A1 to A7, the inks embodying the dispersion of the present disclosure exhibited higher light fastness than the inks in which a colorant was singly used. Also, the results of Comparative Examples A8 to A11 and Comparative Examples A12 to A15 clearly show that the light fastness of the inks not containing the compound of general formula (1) was not significantly improved, and suggest that the combinations of a dye and an ultraviolet light absorbent applied in the Examples are beneficial.

### Preparation of Magenta Toners

Magenta toners were prepared according to the following procedure.

### Example A101

Dispersion (A) was prepared by mixing 10 parts of compound (1-16), 10 parts of compound (2-5), and 120 parts of styrene monomer with an attritor (manufactured by Nippon Coke & Engineering) for 3 hours.

Into a 2 L four-neck flask equipped with a high-speed agitator T. K. Homomixer (manufactured by PRIMIX) was added 710 parts of ion exchanged water and 450 parts of 0.1 mol/L trisodium phosphate aqueous solution, and the mixture was heated to 60° C. while being agitated at a rotational speed of 12000 rpm. To this mixture was gradually added 68 parts of 1.0 mol/L calcium chloride aqueous solution to yield an aqueous dispersion medium containing small particles of poorly water-soluble calcium phosphate.
Dispersion (A): 140.0 parts
Styrene monomer: 46.0 parts
n-Butyl acrylate monomer: 34.0 parts
Aluminum salicylate-based compound: 2.0 parts (Bontron E-88 produced by Orient Chemical Industries)
Polar resin: 10.0 parts
(polycondensate of propylene oxide-modified bisphenol A and isophthalic acid, Tg=65° C., Mw=10000, Mn=6000)
Ester wax: 25.0 parts
(DSC-measured maximum endothermic peak temperature=70° C., Mn=704)

The above listed materials were uniformly dissolved or dispersed at 60° C. with T. K. Homomixer at a rotational speed of 5000 rpm. In this mixture was dissolved 10 parts of polymerization initiator 2,2′-azobis(2,4-dimethylvaleronitrile) to yield a polymerizable monomer composition. The polymerizable monomer composition was added to the above-prepared aqueous dispersion medium and was subjected to granulation at a constant rotational speed of 12000 rpm for 15 minutes. Then, the high-speed agitator was replaced with an agitator including a propeller stirring blade, and the polymerization was continued at 60° C. for 5 hours and was further continued at 80° C. for 8 hours. After the completion of polymerization, the residual monomer was evaporated at 80° C. under reduced pressure, and the sample was cooled to 30° C. to yield a dispersion liquid of polymer fine particles.

Subsequently, the dispersion of the polymer fine particles was placed in a cleaning vessel, and the pH of the dispersion was adjusted to 1.5 by adding dilute hydrochloric acid with stirring. Then, the dispersion was further stirred for 2 hours. The dispersion was filtered for liquid-solid separation, and thus polymer fine particles were obtained. Dispersion of the polymer fine particles in water and solid-liquid separation were repeated until the calcium phosphate was sufficiently removed. Subsequently, the polymer fine particles finally obtained by solid-liquid separation were sufficiently dried with a dryer to yield magenta toner base particles (1).

Into 100 parts of the resulting magenta toner base particles (1) were mixed 1.00 part of hydrophobic silica fine powder (number average primary particle size: 7 nm) surface-treated with hexamethyldisilazane, 0.15 part of rutile-type titanium oxide fine powder (number average primary particle size: 45 nm), and 0.50 part of rutile-type titanium oxide fine powder (number average primary particle size: 200 nm) for 5 minutes in a dry process using a Henschel mixer (manufactured by Nippon Coke & Engineering) to yield magenta toner (1).

### Example A102

Magenta toner (2) was prepared in the same manner as in Example A101, except that compound (2-5) was replaced with 10.5 parts of compound (3-3).

### Example A103

Magenta toner (3) was prepared in the same manner as in Example A101, except that compound (2-5) was replaced with 11.0 parts of compound (4-3).

### Comparative Example A101

Comparative magenta toner (1) was prepared in the same manner as in Example A101, except that compound (1-16) was replaced with comparative compound 3.

### Example A104

A solution was prepared by mixing 82.6 parts of styrene, 9.2 parts of n-butyl acrylate, 1.3 parts of acrylic acid, 0.4 part of hexanediol acrylate, and 3.2 parts of n-laurylmercaptan and dissolving the mixture. To the resulting solution, a solution of 1.5 parts of Neogen RK (produced by Dai-ichi Kogyo Seiyaku) in 150 parts of ion exchanged water was added for dispersion. Then, a solution of 0.15 part of potassium persulfate in 10 parts of ion exchanged water was further added to the resulting dispersion over a period of 10 minutes with slow stirring. The reaction system was purged with nitrogen, and emulsion polymerization was performed at 70° C. for 6 hours. After the completion of the polymerization, the reaction liquid was cooled to room temperature, and to which ion exchanged water was added to yield resin particle dispersion liquid containing resin particles having a median diameter of 0.2 μm on a volume basis with a solids content of 12.5%.

In 385 parts of ion exchanged water were mixed 100 parts of ester wax (DSC-measured maximum endothermic peak temperature=70° C., Mn=704) and 15 parts of Neogen RK. The mixture was agitated with a wet jet mill JN100 (manufactured by Jokoh) for about 1 hour to yield a wax dispersion liquid. The solids content of the wax dispersion liquid was 20%.

In 785 parts of ion exchanged water were mixed 100 parts of compound (1-1), 100 parts of compound (4-2), and 15 parts of Neogen RK. The mixture was agitated with a wet jet mill JN100 (manufactured by Jokoh) for 1 hour to yield a compound (1-1) dispersion liquid. The solids content of the compound (1-1) dispersion liquid was 10%.

With a homogenizer ULTRA-TURRAX T50 (manufactured by IKA) were dispersed 160 parts of the above-prepared resin particle dispersion liquid, 10 parts of the wax dispersion liquid, 20 parts of the compound (1-1) dispersion liquid, and 0.2 part of magnesium sulfate in each other, and the mixture was heated to 65° C. while being agitated. After being agitated at 65° C. for 1 hour, the mixture was observed under an optical microscope. Aggregated particles having a particle size of about 6.0 μm were observed. Then, 2.2 parts of Neogen RK (produced by Dai-ichi Kogyo Seiyaku) was added, and the sample was heated to 80° C. and agitated for 120 minutes to yield fused spherical toner particles. After being cooled, the resulting particles were filtered, and the solids separated out by filtration were stirred for 60 minutes in 720 parts of ion exchanged water for washing. The liquid containing toner particles was filtered. This operation was repeated until the electric conductivity of the filtrate was reduced to 150 μS/cm or less. Then, the toner particles were dried with a vacuum dryer to yield magenta toner base particles (4).

The resulting magenta toner base particles (4) in a proportion of 100 parts were mixed with 1.8 parts of hydrophobized silica fine powder having a specific surface area (measured by the BET method) of 200 m²/g in a dry process with a Henschel mixer (manufactured by Nippon Coke & Engineering) to yield magenta toner (4).

### Comparative Example A102

Comparative magenta toner (2) was prepared in the same manner as in Example A104, except that compound (1-1) was replaced with comparative compound 4.

### Example A105

Binder resin (polyester resin, Tg: 55° C., acid value: 20 mg KOH/g, hydroxyl value: 16 mg KOH/g, molecular weight: Mp=4500, Mn=2300, Mw=38000): 100 parts
Compound (1-1): 5 parts
Compound (3-3): 10 parts
Aluminum 1,4-di-t-butylsalicylate: 0.5 part
Paraffin wax (highest endothermic peak temperature: 78° C.) 5 parts

These materials were sufficiently mixed in a Henschel mixer (FM-75J, manufactured by Nippon Coke & Engineering). The mixture was kneaded at a feed rate of 60 kg/h in a twin screw kneader (PCM-45, manufactured by Ikegai) set at a temperature of 130° C. (temperature of the mixture during extrusion was about 150° C.). After being cooled, the resulting mixture was crushed with a hammer mill, and further pulverized to a much smaller particle size with a mechanical pulverizer (T-250, manufactured by Turbo Kogyo) at a feed rate of 20 kg/h. The finely pulverized powder was sized with a multi-classification classifier using the Coanda effect to yield magenta toner base particles (5).

The resulting magenta toner base particles (5) in a proportion of 100 parts were mixed with 1.8 parts of hydrophobized silica fine powder having a specific surface area (measured by the BET method) of 200 m²/g in a dry process with a Henschel mixer (manufactured by Nippon Coke & Engineering) to yield magenta toner (5).

### Comparative Example A103

Comparative magenta toner (3) was prepared in the same manner as in Example A105, except that compound (1-1) was replaced with comparative compound 4.

### Examinations

The magenta toners prepared as above were subjected to the following tests for evaluation.

### (1) Evaluation for Image Samples

Image samples were prepared with magenta toners (1) to (5) and comparative magenta toners (1) and (3). The image properties of the image samples were compared for evaluation. For comparing image properties, an image forming apparatus modified from LBP-5300 (manufactured by Canon) was used. More specifically, the developer blade in the process cartridge of the image forming apparatus was replaced with an 8 μm-thick SUS blade. Furthermore, the image forming apparatus was modified so that a bias of −200 V, which was originally intended to be applied as a developing bias to the developing roller that is the toner bearing member, could be applied to the blade as a blade bias.

### Toner Light Fastness Test

Each image sample was subjected to an exposure test under the conditions of an illuminance of 340 nm at 0.39 W/m², a temperature of 40° C. and a relative humidity of 70% for 100 hours in a xenon test apparatus Atlas Ci 4000 (manufactured by Suga Test Instruments). For each sample, the color parameters were measured before and after the test, and ΔE represented by the following equation was calculated:

ΔE=\sqrt{(a*−a*₀)²+(b*−b*₀)²+(L*−L*₀)²}

In the equation, a₀*, b₀*, and L₀* represent the initial color parameters, and a*, b*, and L* represent the color parameters after exposure. The results are shown in Table 2.

The results were rated according to the following criteria:
A: ΔE<10 (excellent light fastness)
B: 10≦ΔE<20 (good light fastness)
C: 20≦ΔE (poor light fastness)

TABLE 2
Table 2

| | | | | | Light |
|---|---|---|---|---|---|
| | | | Ultraviolet | Toner | fastness |
| | | | light | production | ΔE/ |
| | Toner No. | Colorant | absorbent | process | Rating |
| Example A101 | Magenta toner (1) | Compound (1-16) | Compound (2-5) | Suspension | 13/B |
| | | | | polymerization | |
| Example A102 | Magenta toner (2) | Compound (1-16) | Compound (3-3) | Suspension | 18/B |
| | | | | polymerization | |
| Example A103 | Magenta toner (3) | Compound (1-16) | Compound (4-3) | Suspension | 15/B |
| | | | | polymerization | |
| Example A104 | Magenta toner (4) | Compound (1-1) | Compound (4-2) | Emulsion | 14/B |
| | | | | polymerization | |
| Example A105 | Magenta toner (5) | Compound (1-1) | Compound (3-3) | Pulverization | 9/A |
| Comparative | Comparative | Comparative | Compound (2-5) | Suspension | 125/C |
| Example A101 | magenta toner (1) | Compound 3 | | polymerization | |
| Comparative | Comparative | Comparative | Compound (4-2) | Emulsion | 108/C |
| Example A102 | magenta toner (2) | Compound 4 | | polymerization | |
| Comparative | Comparative | Comparative | Compound (3-3) | Pulverization | 107/C |
| Example A103 | magenta toner (3) | Compound 4 | | | |

It is shown that the magenta toners according to the present disclosure are superior in light fastness to the comparative magenta toners. This suggests that the combination of a colorant and an ultraviolet light absorbent according to the present disclosure produces a notable effect.

### Preparation of Ink (Dye Dispersion)

Each ink was prepared by mixing 150 parts of the colorant shown in Table 3, 150 parts of the ultraviolet light absorbent shown in Table 3, 350 parts of toluene, 350 parts of ethyl acetate, and 300 parts of 2-butanone.

Comparative Compounds 5 to 9 shown in Table 3 have the following structures:

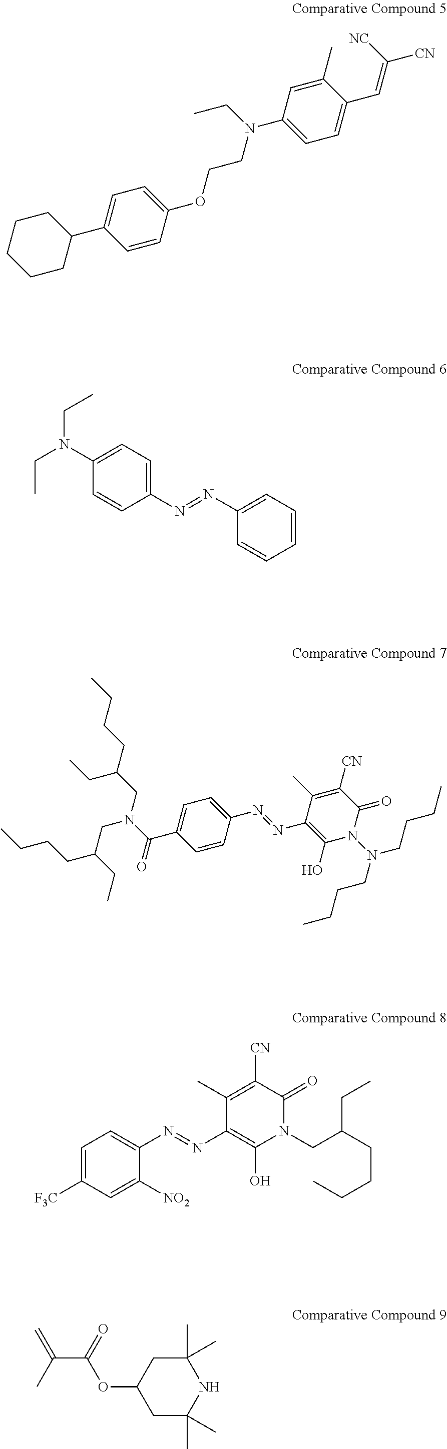

### Examinations

### Preparation of Samples

Each ink was applied onto coverage measurement test paper by bar coating (Bar No. 10) and was then allowed to stand overnight for drying. Thus, image samples were prepared.

### Light Fastness Test

Each image sample was subjected to an exposure test under the conditions of an illuminance of 340 nm at 0.39 W/m², a temperature of 40° C. and a relative humidity of 70% for 20 hours in a xenon test apparatus Atlas Ci 4000 (manufactured by Suga Test Instruments). For each sample, the color parameters (L*, a*, and b*) in the CIE L*a*b* color system were measured before and after the test with a reflection densitometer SpectroLino (manufactured by Gretag Macbeth), and ΔE represented by the following equation was calculated:

ΔE=\sqrt{(a*−a*₀)²+(b*−b*₀)²+(L*−L*₀)²}

In the equation, a₀*, b₀*, and L₀* represent the initial color parameters, and a*, b*, and L* represent the color parameters after exposure. The results are shown in Table 3.

The results were rated according to the following criteria:
A: ΔE≦10 (good short-time light fastness)
B: 10<ΔE (poor short-time light fastness)

The samples rated as A in the above test were further subjected to an exposure test for 180 hours under the conditions of an illuminance of 340 nm at 0.39 W/m², a temperature of 40° C. and a relative humidity of 70%. Then, ΔE of the image samples was calculated. For this calculation, the color parameters before the 20-hour exposure test were used as the initial color parameters. The results are shown in Table 3.

The results were rated according to the following criteria:
A: ΔE≦10 (excellent long-time light fastness)
B: 10<ΔE≦20 (good long-time light fastness)
C: 20≦ΔE (poor long-time light fastness)

TABLE 3
Table 3

| | | Ultraviolet | | ΔE/ |
|---|---|---|---|---|
| | | light | ΔE/Rating | Rating |
| | Colorant | absorbent | Short time | Long time |
| Example B1 | Compound (6-19) | Compound (2-5) | Less than 1/A | 7/A |
| Example B2 | Compound (6-20) | Compound (2-5) | Less than 1/A | 5/A |
| Example B3 | Compound (6-21) | Compound (2-5) | Less than 1/A | 3/A |
| Example B4 | Compound (6-24) | Compound (2-5) | Less than 1/A | 3/A |
| Example B5 | Compound (6-25) | Compound (2-5) | Less than 1/A | 4/A |
| Example B6 | Compound (6-26) | Compound (2-5) | Less than 1/A | 8/A |
| Example B7 | Compound (6-21) | Compound (2-7) | Less than 1/A | 5/A |
| Example B8 | Compound (6-21) | Compound (3-3) | Less than 1/A | 8/A |
| Example B9 | Compound (6-21) | Compound (4-2) | Less than 1/A | 7/A |
| Comparative | Compound (6-19) | — | 2/A | 32/C |
| Example B1 | | | | |
| Comparative | Compound (6-20) | — | Less than 1/A | 17/B |
| Example B2 | | | | |
| Comparative | Compound (6-21) | — | Less than 1/A | 19/B |
| Example B3 | | | | |
| Comparative | Compound (6-24) | — | Less than 1/A | 36/C |
| Example B4 | | | | |
| Comparative | Compound (6-25) | — | Less than 1/A | 33/C |
| Example B5 | | | | |
| Comparative | Compound (6-26) | — | 3/A | 44/C |
| Example B6 | | | | |
| Comparative | Comparative | — | 52/B | — |
| Example B7 | Compound 5 | | | |
| Comparative | Comparative | Compound (2-5) | 8/A | 34/C |
| Example B8 | Compound 6 | | | |
| Comparative | Comparative | Compound (2-7) | 13/B | — |
| Example B9 | Compound 7 | | | |
| Comparative | Comparative | Compound (3-3) | 9/A | 36/C |
| Example B10 | Compound 8 | | | |
| Comparative | Comparative | Compound (4-2) | 36/B | — |
| Example B11 | Compound 5 | | | |
| Comparative | Comparative | — | 15/B | — |
| Example B12 | Compound 6 | | | |
| Comparative | Comparative | — | 20/B | — |
| Example B13 | Compound 7 | | | |
| Comparative | Comparative | — | 23/B | — |
| Example B14 | Compound 8 | | | |
| Comparative | Compound (6-21) | Comparative | 4/A | 85/C |
| Example B15 | | Compound 9 | | |

As is clear from the results of Examples B1 to B9 and Comparative Examples B1 to B6, the inks embodying the dispersion of the present disclosure exhibited higher light fastness than the inks in which a colorant was singly used. Also, the results of Comparative Examples B7 to B10 and Comparative Examples B11 to B14 show that the colorant having the structure shown in general formula (6) exhibited improved light fastness in terms of a certain viewpoint, but were not insufficient in long-time light fastness. However, when the compound having the structure of general formula (6) was combined with an ultraviolet light absorbent, high light fastness was exhibited. This suggests that such a combination is beneficial. In Comparative Example B15, hindered amine, which is generally known to be effective in improving light fastness, was added. It is however not confirmed that the hindered amine improved the light fastness of the compound having the structure of general formula (6).

### Preparation of Yellow Toners

Yellow toners were prepared according to the following procedure.

### Example B101

Dispersion (B) was prepared by mixing 10 parts of compound (6-21), 10 parts of compound (2-5), and 120 parts of styrene monomer with an attritor (manufactured by Nippon Coke & Engineering) for 3 hours.

Into a 2 L four-neck flask equipped with a high-speed agitator T. K. Homomixer (manufactured by PRIMIX) was added 710 parts of ion exchanged water and 450 parts of 0.1 mol/L trisodium phosphate aqueous solution, and the mixture was heated to 60° C. while being agitated at a rotational speed of 12000 rpm. To this mixture was gradually added 68 parts of 1.0 mol/L calcium chloride aqueous solution to yield an aqueous dispersion medium containing small particles of poorly water-soluble calcium phosphate.
Dispersion (B): 140.0 parts
Styrene monomer: 46.0 parts
n-Butyl acrylate monomer: 34.0 parts
Aluminum salicylate-based compound: 2.0 parts (Bontron E-88 produced by Orient Chemical Industries)
Polar resin: 10.0 parts
(polycondensate of propylene oxide-modified bisphenol A and isophthalic acid, Tg=65° C., Mw=10000, Mn=6000)
Ester wax: 25.0 parts
(DSC-measured maximum endothermic peak temperature=70° C., Mn=704)

The above listed materials were uniformly dissolved or dispersed at 60° C. with T. K. Homomixer at a rotational speed of 5000 rpm. In this mixture was dissolved 10 parts of polymerization initiator 2,2′-azobis(2,4-dimethylvaleronitrile). Thus, a polymerizable monomer composition was prepared. The polymerizable monomer composition was added to the above-prepared aqueous dispersion medium and was subjected to granulation at a constant rotational speed of 12000 rpm for 15 minutes. Then, the high-speed agitator was replaced with an agitator including a propeller stirring blade, and the polymerization was continued at 60° C. for 5 hours and was further continued at 80° C. for 8 hours. After the completion of polymerization, the residual monomer was evaporated at 80° C. under reduced pressure, and the sample was cooled to 30° C. to yield a dispersion liquid of polymer fine particles.

Subsequently, the dispersion of the polymer fine particles was placed in a cleaning vessel, and the pH of the dispersion was adjusted to 1.5 by adding dilute hydrochloric acid with stirring. Then, the dispersion was further stirred for 2 hours. The dispersion was filtered for liquid-solid separation, and thus polymer fine particles were obtained. Dispersion of the polymer fine particles in water and solid-liquid separation were repeated until the calcium phosphate was sufficiently removed. Subsequently, the polymer fine particles finally obtained by solid-liquid separation were sufficiently dried with a dryer to yield yellow toner base particles (1).

Into 100 parts of the resulting yellow toner base particles (1) were mixed 1.00 part of hydrophobic silica fine powder (number average primary particle size: 7 nm) surface-treated with hexamethyldisilazane, 0.15 part of rutile-type titanium oxide fine powder (number average primary particle size: 45 nm), and 0.50 part of rutile-type titanium oxide fine powder (number average primary particle size: 200 nm) for 5 minutes in a dry process using a Henschel mixer (manufactured by Nippon Coke & Engineering) to yield yellow toner (1).

### Example B102

Yellow toner (2) was prepared in the same manner as in Example B101, except that compound (2-5) was replaced with 10.5 parts of compound (3-3).

### Example B103

Yellow toner (3) was prepared in the same manner as in Example B101, except that compound (2-5) was replaced with 11.0 parts of compound (4-3).

### Comparative Example B101

Comparative yellow toner (1) was prepared in the same manner as in Example B101, except that compound (6-21) was replaced with comparative compound 5.

### Example B104

A solution was prepared by mixing 82.6 parts of styrene, 9.2 parts of n-butyl acrylate, 1.3 parts of acrylic acid, 0.4 part of hexanediol acrylate, and 3.2 parts of n-laurylmercaptan and dissolving the mixture. To the resulting solution, a solution of 1.5 parts of Neogen RK (produced by Dai-ichi Kogyo Seiyaku) in 150 parts of ion exchanged water was added for dispersion. Then, a solution of 0.15 part of potassium persulfate in 10 parts of ion exchanged water was further added to the resulting dispersion over a period of 10 minutes with slow stirring. The reaction system was purged with nitrogen, and emulsion polymerization was performed at 70° C. for 6 hours. After the completion of the polymerization, the reaction liquid was cooled to room temperature, and to which ion exchanged water was added to yield resin particle dispersion liquid containing resin fine particles having a median diameter of 0.2 μm on a volume basis with a solids content of 12.5%.

In 385 parts of ion exchanged water were mixed 100 parts of ester wax (DSC-measured maximum endothermic peak temperature=70° C., Mn=704) and 15 parts of Neogen RK. The mixture was agitated with a wet jet mill JN100 (manufactured by Jokoh) for about 1 hour to yield a wax dispersion liquid. The solids content of the wax dispersion liquid was 20%.

In 785 parts of ion exchanged water were mixed 100 parts of compound (6-20), 100 parts of compound (3-3), and 15 parts of Neogen RK. The mixture was agitated with a wet jet mill JN100 (manufactured by Jokoh) for about 1 hour to yield a compound (6-20) dispersion liquid. The solids content of the compound (6-20) dispersion liquid was 10%.

With a homogenizer ULTRA-TURRAX T50 (manufactured by IKA) were dispersed 160 parts of the above-prepared resin particle dispersion liquid, 10 parts of the wax dispersion liquid, 20 parts of the compound (6-20) dispersion liquid, and 0.2 part of magnesium sulfate in each other, and the mixture was heated to 65° C. while being agitated. After being agitated at 65° C. for 1 hour, the mixture was observed under an optical microscope. Aggregated particles having a particle size of about 6.0 μm were observed. Then, 2.2 parts of Neogen RK (produced by Dai-ichi Kogyo Seiyaku) was added, and the sample was heated to 80° C. and agitated for 120 minutes to yield fused spherical toner particles. After being cooled, the resulting particles were filtered, and the solids separated out by filtration were stirred for 60 minutes in 720 parts of ion exchanged water for washing. The liquid containing toner particles was filtered. This operation was repeated until the electric conductivity of the filtrate was reduced to 150 μS/cm or less. Then, the toner particles were dried in a vacuum dryer to yield yellow toner base particles (4).

The resulting yellow toner base particles (4) in a proportion of 100 parts were mixed with 1.8 parts of hydrophobized silica fine powder having a specific surface area (measured by the BET method) of 200 m²/g in a dry process with a Henschel mixer (manufactured by Nippon Coke & Engineering) to yield yellow toner (4).

### Comparative Example B102

Comparative yellow toner (2) was prepared in the same manner as in Example B104, except that compound (6-20) was replaced with comparative compound 6.

### Example B105

Binder resin (polyester resin, Tg: 55° C., acid value: 20 mg KOH/g, hydroxyl value: 16 mg KOH/g, molecular weight: Mp=4500, Mn=2300, Mw=38000): 100 parts
Compound (6-20): 5 parts
Compound (4-2): 10 parts
Aluminum 1,4-di-t-butylsalicylate: 0.5 part
Paraffin wax (highest endothermic peak temperature: 78° C.) 5 parts

These materials were sufficiently mixed in a Henschel mixer (FM-75J, manufactured by Nippon Coke & Engineering). The mixture was kneaded at a feed rate of 60 kg/h in a twin screw kneader (PCM-45, manufactured by Ikegai) set at a temperature of 130° C. (temperature of the mixture during extrusion was about 150° C.). After being cooled, the resulting mixture was crushed with a hammer mill, and further pulverized to a much smaller particle size with a mechanical pulverizer (T-250, manufactured by Turbo Kogyo) at a feed rate of 20 kg/h. The finely pulverized powder was sized with a multi-classification classifier using the Coanda effect to yield yellow toner base particles (5).

The resulting yellow toner base particles (5) in a proportion of 100 parts were mixed with 1.8 parts of hydrophobized silica fine powder having a specific surface area (measured by the BET method) of 200 m²/g in a dry process with a Henschel mixer (manufactured by Nippon Coke & Engineering) to yield yellow toner (5).

### Comparative Example B103

Comparative yellow toner (3) was prepared in the same manner as in Example B105, except that compound (6-20) was replaced with comparative compound 7.

### Examinations

Image samples were prepared using yellow toners (1) to (5) and comparative yellow toners (1) to (3). The image properties of the image samples were compared for evaluation. For comparing image properties, an image forming apparatus modified from LBP-5300 (manufactured by Canon) was used. More specifically, the developer blade in the process cartridge of the image forming apparatus was replaced with an 8 μm-thick SUS blade. Furthermore, the image forming apparatus was modified so that a bias of −200 V, which was originally intended to be applied as a developing bias to the developing roller that is the toner bearing member, could be applied to the blade as a blade bias.

### Toner Light Fastness Test

Each image sample was subjected to an exposure test under the conditions of an illuminance of 340 nm at 0.39 W/m², a temperature of 40° C. and a relative humidity of 70% for 100 hours in a xenon test apparatus Atlas Ci 4000 (manufactured by Suga Test Instruments). For each sample, the color parameters were measured before and after the test, and ΔE represented by the following equation was calculated:

ΔE=\sqrt{(a*−a*₀)²+(b*−b*₀)²+(L*−L*₀)²}

In the equation, a₀*, b₀*, and L₀* represent the initial color parameters, and a*, b*, and L* represent the color parameters after exposure. The results are shown in Table 4.

The results were rated according to the following criteria:
A: ΔE<10 (excellent light fastness)
B: 10≦ΔE<20 (good light fastness)
C: 20≦ΔE (poor light fastness)

TABLE 4
Table 4

| | | | | | Light |
|---|---|---|---|---|---|
| | | | Ultraviolet | Toner | fastness |
| | | | light | production | ΔE/ |
| | Toner No. | Colorant | absorbent | process | Rating |
| Example B101 | Yellow toner (1) | Compound (6-21) | Compound (2-5) | Suspension | 9/A |
| | | | | polymerization | |
| Example B102 | Yellow toner (2) | Compound (6-21) | Compound (3-3) | Suspension | 14/B |
| | | | | polymerization | |
| Example B103 | Yellow toner (3) | Compound (6-21) | Compound (4-3) | Suspension | 11/B |
| | | | | polymerization | |
| Example B104 | Yellow toner (4) | Compound (6-20) | Compound (3-3) | Emulsion | 16/B |
| | | | | polymerization | |
| Example B105 | Yellow toner (5) | Compound (6-20) | Compound (4-2) | Pulverization | 18/B |
| Comparative | Comparative | Comparative | Compound (2-5) | Suspension | 97/C |
| Example B101 | Yellow toner (1) | Compound 5 | | polymerization | |
| Comparative | Comparative | Comparative | Compound (3-3) | Emulsion | 123/C |
| Example B102 | Yellow toner (2) | Compound 6 | | polymerization | |
| Comparative | Comparative | Comparative | Compound (4-2) | Pulverization | 74/C |
| Example B103 | Yellow toner (3) | Compound 7 | | | |

It is shown that the yellow toners according to the present disclosure are superior in light fastness to the comparative yellow toners. This suggests that the combination of a colorant and an ultraviolet light absorbent according to the present disclosure produces a notable effect.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-192724 filed Sep. 30, 2016, which is hereby incorporated by reference herein in its entirety.

What is claimed is:

1. A mixture comprising:
a compound represented by one of general formulas (1) and (6); and
at least one compound selected from the compounds represented by general formulas (2) to (5): 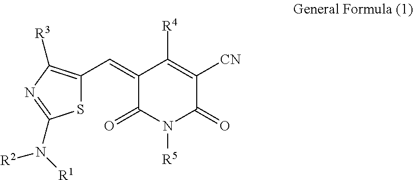
wherein in the general formula (1),
R¹ and R² each represent an alkyl group,
R³ represents a chemical species selected from the group consisting of a hydrogen atom, alkyl groups, unsubstituted aryl groups, and substituted aryl groups,
R⁴ represents a chemical species selected from the group consisting of alkyl groups, unsubstituted aryl groups, and substituted aryl groups, and
R⁵ represents a chemical species selected from the group consisting of a hydrogen atom, alkyl groups, unsubstituted aryl groups, substituted aryl groups, and —N(—R⁶)R⁷, wherein R⁶ and R⁷ each independently represent a chemical species selected from the group consisting of a hydrogen atom, alkyl groups, and acyl groups, or represent atomic groups capable of binding with each other to form a ring structure; 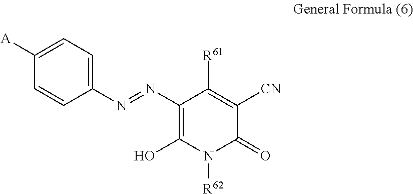
wherein in the general formula (6),
R⁶¹ and R⁶² each represent an alkyl group, and
A represents a group selected from the group consisting of —SO₂N(R⁶³)R⁶⁴, —CON(R⁶³)R⁶⁴, and —COOR⁶³, wherein R⁶³ and R⁶⁴ each independently represent a chemical species selected from the group consisting of a hydrogen atom and alkyl groups; 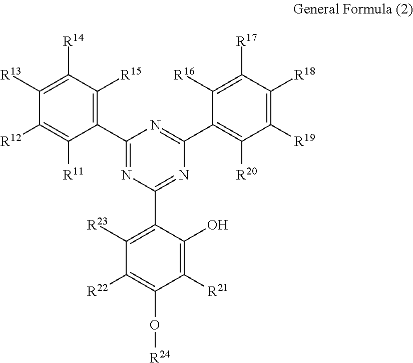
wherein in the general formula (2),
R¹¹ and R¹⁶ each independently represent a chemical species selected from the group consisting of a hydrogen atom, alkyl groups, alkoxy groups, and a hydroxy group,
R¹², R¹⁴, R¹⁵, R¹⁷, R¹⁹, R²⁰, R²¹, R²², and R²³ each independently represent a chemical species selected from the group consisting of a hydrogen atom and alkyl groups,
R¹³ and R¹⁸ each independently represent a chemical species selected from the group consisting of a hydrogen atom, alkyl groups, and alkoxy groups, and
R²⁴ represents a chemical species selected from the group consisting of a hydrogen atom, alkyl groups, and alkyl groups having a hydroxy group; 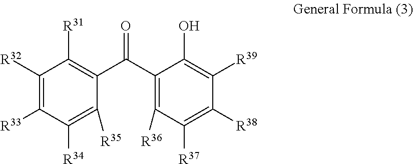
wherein in the general formula (3),
R³¹ represents a chemical species selected from the group consisting of a hydrogen atom, alkyl groups, and a hydroxy group,
R³², R³⁴, R³⁵, R³⁶, R³⁷, and R³⁹ each independently represent a chemical species selected from the group consisting of a hydrogen atom and alkyl groups, and
R³³ and R³⁸ each independently represent a chemical species selected from the group consisting of a hydrogen atom, a hydroxy group, and alkoxy groups; 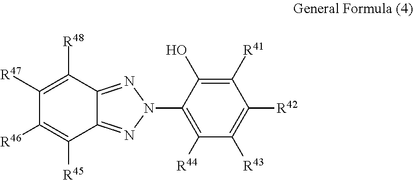
wherein in the general formula (4),
R⁴¹ and R⁴³ each independently represent a chemical species selected from the group consisting of a hydrogen atom, alkyl groups, unsubstituted aryl groups, and substituted aryl groups, and
R⁴² and R⁴⁴ to R⁴⁸ each independently represent a chemical species selected from the group consisting of a hydrogen atom and alkyl groups; and 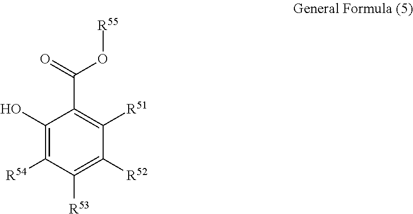
wherein in the general formula (5),
R⁵¹ to R⁵⁴ each independently represent a chemical species selected from the group consisting of a hydrogen atom and alkyl groups, and
R⁵⁵ represents a chemical species selected from the group consisting of alkyl groups, alkyl groups having an aryl group as a substituent, unsubstituted aryl groups, and substituted aryl groups.

2. The mixture according to claim 1, comprising a compound represented by the general formula (1), and wherein
R³ represents a chemical species selected from the group consisting of alkyl groups, unsubstituted aryl groups, and substituted aryl groups,
R⁴ represents an alkyl group, and
R⁵ represents a group selected from the group consisting of alkyl groups and —N(—R⁶)R⁷, wherein R⁶ and R⁷ are each independently a chemical species selected from the group consisting of a hydrogen atom, alkyl groups, and acyl groups.

3. The mixture according to claim 1, comprising a compound represented by the general formula (6), and wherein
A represents —CON(R⁶³)R⁶⁴.

4. The mixture according to claim 1, comprising the compound represented by general formula (2), and wherein
R¹¹ and R¹⁶ each independently represent a chemical species selected from the group consisting of a hydrogen atom, alkyl groups, and a hydroxy group,
R¹³ and R¹⁸ each independently represent an alkyl group, and
R²⁴ represents an alkyl group.

5. The mixture according to claim 1, comprising the compound represented by general formula (3), and wherein
R³¹ represents one of a hydrogen atom and a hydroxy group,
R³², R³⁴, R³⁵, R³⁶, R³⁷, and R³⁹ each independently represent a hydrogen atom, and
R³³ and R³⁸ each independently represent a chemical species selected from the group consisting of a hydrogen atom and alkyl groups.

6. The mixture according to claim 1, comprising the compound represented by general formula (4), and wherein
R⁴¹ and R⁴³ each independently represents a chemical species selected from the group consisting of a hydrogen atom and alkyl groups, and
R⁴² and R⁴⁴ to R⁴⁸ each represent a hydrogen atom.

7. A toner comprising:
a binder resin;
a compound represented by one of general formulas (1) and (6); and
at least one compound selected from the compounds represented by general formulas (2) to (5): 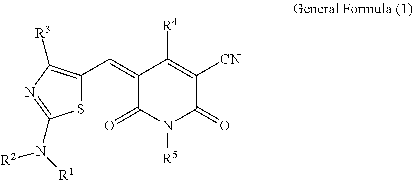
wherein in the general formula (1),
R¹ and R² each represent an alkyl group,
R³ represents a chemical species selected from the group consisting of a hydrogen atom, alkyl groups, unsubstituted aryl groups, and substituted aryl groups,
R⁴ represents a chemical species selected from the group consisting of alkyl groups, unsubstituted aryl groups, and substituted aryl groups, and
R⁵ represents a chemical species selected from the group consisting of a hydrogen atom, alkyl groups, unsubstituted aryl groups, substituted aryl groups, and —N(—R⁶)R⁷, wherein R⁶ and R⁷ each independently represent a chemical species selected from the group consisting of a hydrogen atom, alkyl groups, and acyl groups, or represent atomic groups capable of binding with each other to form a ring structure; 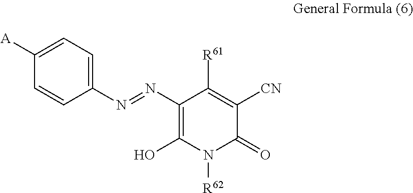
wherein in the general formula (6),
R⁶¹ and R⁶² each represent an alkyl group, and
A represents a group selected from the group consisting of —SO₂N(R⁶³)R⁶⁴, —CON(R⁶³)R⁶⁴, and —COOR⁶³, wherein R⁶³ and R⁶⁴ each independently represent a chemical species selected from the group consisting of a hydrogen atom and alkyl groups; 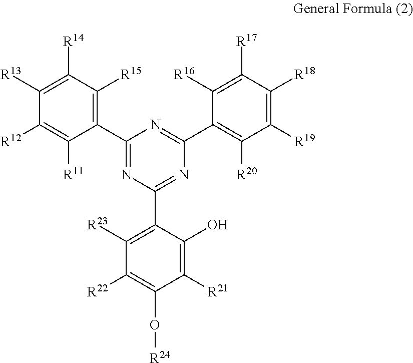
wherein in the general formula (2),
R¹¹ and R¹⁶ each independently represent a chemical species selected from the group consisting of a hydrogen atom, alkyl groups, alkoxy groups, and a hydroxy group,
R¹², R¹⁴, R¹⁵, R¹⁷, R¹⁹, R²⁰, R²¹, R²², and R²³ each independently represent a chemical species selected from the group consisting of a hydrogen atom and alkyl groups,
R¹³ and R¹⁸ each independently represent a chemical species selected from the group consisting of a hydrogen atom, alkyl groups, and alkoxy groups, and
R²⁴ represents a chemical species selected from the group consisting of a hydrogen atom, alkyl groups, and alkyl groups having a hydroxy group; 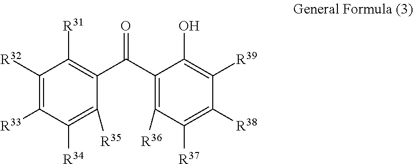
wherein in the general formula (3),
R³¹ represents a chemical species selected from the group consisting of a hydrogen atom, alkyl groups, and a hydroxy group,
R³², R³⁴, R³⁵, R³⁶, R³⁷, and R³⁹ each independently represent a chemical species selected from the group consisting of a hydrogen atom and alkyl groups, and
R³³ and R³⁸ each independently represent a chemical species selected from the group consisting of a hydrogen atom, a hydroxy group, and alkoxy groups; 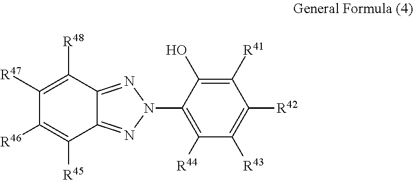
wherein in the general formula (4),
R⁴¹ and R⁴³ each independently represent a chemical species selected from the group consisting of a hydrogen atom, alkyl groups, unsubstituted aryl groups, and substituted aryl groups, and
R⁴² and R⁴⁴ to R⁴⁸ each independently represent a chemical species selected from the group consisting of a hydrogen atom and alkyl groups; and 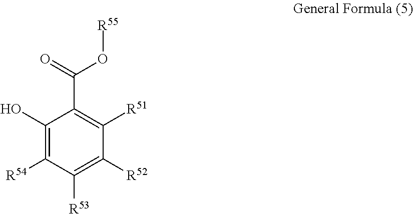
wherein in the general formula (5),
R⁵¹ to R⁵⁴ each independently represent a chemical species selected from the group consisting of a hydrogen atom and alkyl groups, and
R⁵⁵ represents a chemical species selected from the group consisting of alkyl groups, alkyl groups having an aryl group as a substituent, unsubstituted aryl groups, and substituted aryl groups.

8. A dispersion comprising:
a dispersion medium containing at least one of water and an organic solvent;
a compound represented by one of general formulas (1) and (6), the compound being dispersed in the dispersion medium; and
at least one compound selected from the compounds represented by general formulas (2) to (5), the at least one compound being dispersed in the dispersion medium: 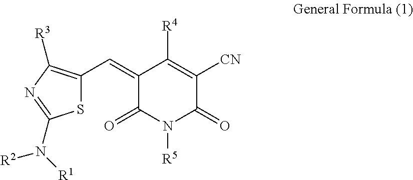
wherein in the general formula (1),
R¹ and R² each represent an alkyl group,
R³ represents a chemical species selected from the group consisting of a hydrogen atom, alkyl groups, unsubstituted aryl groups, and substituted aryl groups,
R⁴ represents a chemical species selected from the group consisting of alkyl groups, unsubstituted aryl groups, and substituted aryl groups, and
R⁵ represents a chemical species selected from the group consisting of a hydrogen atom, alkyl groups, unsubstituted aryl groups, substituted aryl groups, and —N(—R⁶)R⁷, wherein R⁶ and R⁷ each independently represent a chemical species selected from the group consisting of a hydrogen atom, alkyl groups, and acyl groups, or represent atomic groups capable of binding with each other to form a ring structure; 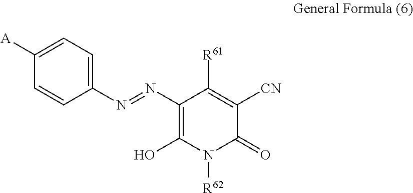
wherein in the general formula (6),
R⁶¹ and R⁶² each represent an alkyl group, and
A represents a group selected from the group consisting of —SO₂N(R⁶³)R⁶⁴, —CON(R⁶³)R⁶⁴, and —COOR⁶³, wherein R⁶³ and R⁶⁴ each independently represent a chemical species selected from the group consisting of a hydrogen atom and alkyl groups; 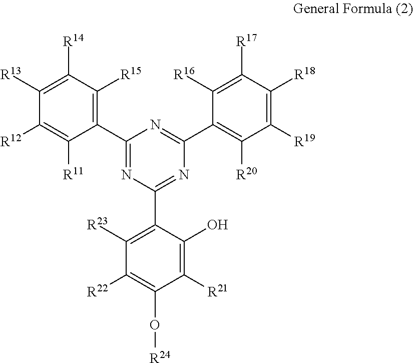
wherein in the general formula (2),
R¹¹ and R¹⁶ each independently represent a chemical species selected from the group consisting of a hydrogen atom, alkyl groups, alkoxy groups, and a hydroxy group,
R¹², R¹⁴, R¹⁵, R¹⁷, R¹⁹, R²⁰, R²¹, R²², and R²³ each independently represent a chemical species selected from the group consisting of a hydrogen atom and alkyl groups,
R¹³ and R¹⁸ each independently represent a chemical species selected from the group consisting of a hydrogen atom, alkyl groups, and alkoxy groups, and
R²⁴ represents a chemical species selected from the group consisting of a hydrogen atom, alkyl groups, and alkyl groups having a hydroxy group; 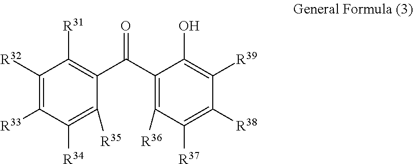
wherein in the general formula (3),
R³¹ represents a chemical species selected from the group consisting of a hydrogen atom, alkyl groups, and a hydroxy group,
R³², R³⁴, R³⁵, R³⁶, R³⁷, and R³⁹ each independently represent a chemical species selected from the group consisting of a hydrogen atom and alkyl groups, and
R³³ and R³⁸ each independently represent a chemical species selected from the group consisting of a hydrogen atom, a hydroxy group, and alkoxy groups; 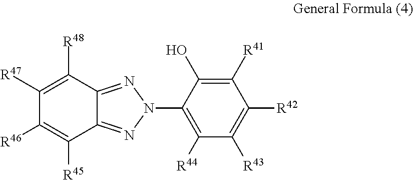
wherein in the general formula (4),
R⁴¹ and R⁴³ each independently represent a chemical species selected from the group consisting of a hydrogen atom, alkyl groups, unsubstituted aryl groups, and substituted aryl groups, and
R⁴² and R⁴⁴ to R⁴⁸ each independently represent a chemical species selected from the group consisting of a hydrogen atom and alkyl groups; and 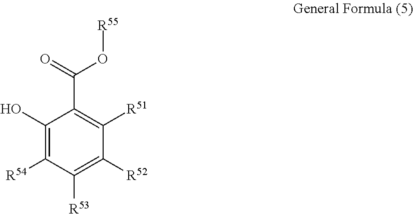
wherein in the general formula (5),
R⁵¹ to R⁵⁴ each independently represent a chemical species selected from the group consisting of a hydrogen atom and alkyl groups, and
R⁵⁵ represents a chemical species selected from the group consisting of alkyl groups, alkyl groups having an aryl group as a substituent, unsubstituted aryl groups, and substituted aryl groups.
